(19) United States
(12) Patent Application Publication
(10) Pub. No.: US 2007/0087382 A1
(43) Pub. Date: Apr. 19, 2007

(54) Molecule array and method for producing the same

(75) Inventors: Stefan Howorka, Linz (AT); Patrick Pammer, Linz (AT)

Correspondence Address: FULBRIGHT & JAWORSKI L.L.P., 600 CONGRESS AVE., SUITE 2400, AUSTIN, TX, 78701, US

(73) Assignee: Upper Austrian Research GmbH, Linz (AT)

(21) Appl. No.: 10/571,456

(22) PCT Filed: Sep. 10, 2004
(86) PCT No.: PCT/AT04/00316

§ 371 Date: Dec. 7, 2006

(30) Foreign Application Priority Data
Sep. 16, 2003 (AT) A 1455/2003
Mar. 5, 2004 (AT) A 389/2004

(51) Int. Cl. C40B 30/06; C40B 40/04

(52) U.S. Cl. 435/7.1; 435/287.1

(57) ABSTRACT

The invention relates to assemblies for bonding molecules comprising bondable functional groups, which are present on a solid supporting material as individual molecular functional groups or multiple identical functional groups. Said assemblies are characterised in that the density of the individual functional groups or multiple functional groups on the solid supporting material is between 10⁴ and 10¹⁰ individual or multiple functional groups per cm² and that there are no additional bondable functional groups within a selected distance d from any individual bondable functional group or multiple functional group for at least 95% and in particular at least 99% of the individual or multiple functional groups.

The present invention relates to arrays for the binding of molecules, in particular to be used as biochips, or for the analysis by means of the “single dye tracing scan” or the “time delayed integration method”, respectively.

The most recent fields of research, such as genomics and proteomics, confront biotechnology with great challenges, wherein the single-molecule microscopy may assume an important position. Common methods of genomics and proteomics are based on assays by means of DNA or protein arrays, in the evaluation of which the ensemble properties of many biomolecules are determined (Arbeitman et al., 2002; MacBeath et al., 2000; Pollack et al., 1999; Zhu et al., 2001). On the other hand, single-molecule microscopy offers a qualitative advantage of basic importance, since individual biomolecules can be examined without their relevant properties being distorted or thinned out by averaging the ensemble observation (Clausen-Schaumann et al., 2000; Mehta et al., 1999; Nie et al., 1997; Schmidt et al., 1996; Segers-Nolten et al., 2002; Xie et al., 1999). Examples of the properties of single molecules are, e.g., the respective set of mutants of a DNA molecule or the individual post-translational modification of each individual/single expressed protein, as well as its state of association with other proteins.

What is required is a technology which allows for an individual and rapid examination of many different biomolecules, or their structural variants, respectively, such as, e.g., the properties of DNA molecules or the type and number of messenger RNA molecules which have been expressed in a cell at a certain state or after a certain treatment (expression profile); furthermore, the detailed profiles of the respective expressed proteins, i.e. the profiles differentiated according to type, number, post-translational modification (phosphorylation, glycosilation, etc.), distribution of the individual proteins in the cell, specific protein-protein associations, and the effect on the activity of the protein.

In order to make a statistically relevant statement, the number of the simultaneously investigated single molecules should be at least a few decimal powers, such as 10⁶ to 10⁸, at an acceptable time of data recovery.

For such an application, employing the single molecule fluorescence microscopy, in particular the SDT-scan or the TDI method, is useful (Hesse et al., 2002; Schindler, 2000). This method has been a routine technique for some years, both for the detection of single fixed or diffusing molecules on surfaces (Schmidt et al., 1996) and of single biomolecules in cells (Schutz et al., 2000; Sonnleitner et al., 1999). The method allows for the ultra-rapid microscopy of molecules on surfaces with a simultaneous single molecule sensitivity. The method allows for the analysis of all individual fluorescence-marked molecules on 1 cm² in approximately 5 min with a very good signal/noise ratio, and thus meets one of the requirements made: the provision of a sufficiently sensitive detection method which, at the same time, is sufficiently rapid.

Single-molecule detection methods, especially single-molecule fluorescence microscopy, contribute substantially to the analysis of protein and DNA-analytes in the field of fundamental science and also serve for the further development of biotechnological methods intended for future use for diagnostic or therapeutic investigations in medicine.

One example of the use of the single-molecule method for diagnostic purposes is DNA hybridization (Korn et al., 2003). DNA hybridization with the help of microarrays is a widely used technology for making it possible to investigate nucleic acids on a genomic scale as well as to utilize them for the purposes of research, diagnosis and therapy. Due to its high sensitivity, single-molecule fluorescence microscopy offers the possibility of avoiding the amplification of the sample DNA and to thereby prevent amplification artefacts and falsified conclusions about the expression levels during expression analyses.

A further application of the single-molecule microscopy is the re-sequencing of e.g. human DNA (Braslavsky et al., 2003; Levene et al., 2003) for obtaining medically important variants, such as SNPs, of the genetic information. With the sequencing methods currently used, the analyte-DNA must be amplified before the sequencing reaction occurs. By using the single-molecule fluorescence microscopy, the step of DNA amplification would be omitted, and this would result in a reduced consumption of reagents and the desired reduction in costs and the acceleration of the sequencing process.

For both single-molecule applications, DNA hybridization and, particularly, DNA sequencing, ideally an optically isolated resolution of the single molecules to be investigated should be possible. For instance, if the distance between two DNA strands is smaller than the optical resolution, the fluorescence signals from the sequencing reaction of both strands will interfere with each other, and the sequence of the strands can no longer be clearly found out.

Accordingly, ideally, the DNA molecules to be examined should be provided individually positioned on a solid substrate. In many of the published studies on single-molecule investigations this demand has not been met. In these studies, the molecules are bound to a surface undirected and statistically randomized, with the consequence that also molecule groups or clusters will form on the surface which cannot be optically resolved. To prevent such an overloading with molecules, diluted molecule solutions are employed with the drawback that the density of molecules on the surface becomes very low; for instance, too low for investigating the relevant portions of the human genome for diagnostically indicative variations.

With the assistance of a DNA array in which single DNA strands are provided at defined positions, it would be possible to optically resolve single DNA strands and also to obtain a high density of DNA analytes. In this array, individual molecules would be present at defined locations such that around a molecule within a radius of larger than or equal to the optical resolution, no further molecule would be present. This single-molecule array would have the further advantage that by knowing the exact position of the analyte on the solid substrate, the differentiation between signal and noise would become easier. The differentiation between the signal and the background noise is important primarily if, in the course of the DNA sequencing, the DNA analyte is processed with fluorescence-labeled reagents which will create the fluorescence background by non-specifically binding to the surface of the solid substrate.

The previously used methods and approaches of arranging molecules in isolated manner on a solid substrate have different disadvantages which make a technological usage within the context of the investigation of single biomolecules seem disadvantageous.

In WO 00/06770 A, arrays of biomolecules are disclosed which, even though certain distances are maintained between the spots of biomolecules, allow for a density of spots which is insufficiently low for many applications. Furthermore, there the molecules cannot be specifically addressed, or the provision of several, mutually different functionalities is not possible. Moreover, the arrays disclosed there cause problems with regard to non-specific bindings, and these arrays cannot be re-used.

The arrays suggested in WO 89/09406 and in WO 98/39688, e.g., based on S-layers with proteins serving as spacers, do have a very high density, yet these arrays are unsuitable for an optical analysis for several reasons: The distance between the functionalities which are in a range of 10 nm, are too small to allow for an optical resolution; the layers are unstable and cannot be built up in a reproducible manner. Furthermore, different functionalities, in particular, addressable functionalities, cannot be provided.

WO 02/061126 introduces an array of biomolecules, in which individual molecules are bound to spherical structures which act as spacers between the molecules. By this, the averaged molecule distance can be adjusted via optical resolution. However, the occupation of the spherical spacers by the biomolecules to be investigated is without orientation and randomized, and will lead either to undesired double or multiple occupations per bead or, when labeling is too low, to an insufficient array density. Moreover, the optical resolution of two molecules on neighboring spherical structures will be obtained only if the molecules are bound at the center of the structures. Since the precise position of the molecule on the spherical structure is not defined, neighboring molecules may be too close and may not be optically resolved.

Bruckbauer (Bruckbauer et al., 2003) describes an array of individual molecules applied by depositing a pipette on the substrate, wherein the depositing process is coupled with an optical detector system. The production process of this method is in series and very slow and therefore not suitable for an application on a larger scale. Moreover, the method requires fluorescence labeling of the biomolecule, and this will restrict the choice of the molecules to be arrayed.

An array of individual biomolecules, or of groups of biomolecules, respectively, is also achieved by stamping, i.e. by the transfer of the molecules from the surface of a nanostructured elastic stamp to the surface of a solid substrate (Renaultt et al., 2003). Just as with the other inventions listed, also with this approach it is not ensured that only individual molecules will be bound at the defined positions.

An array of individual molecules which are localized in small, optically addressable reaction spaces, so-called zero mode waveguides, has been presented (Levene et al., 2003). As with the other methods, the occupation of the reaction spaces with molecules is statistical.

WO 02/18266 describes how single inorganic atoms and molecules can be arranged on a surface with position precision by means of scanning tunneling microscopy (STM). The arrays are to be used as memory media with high information density and therefore are of no biotechnological interest.

The present invention now has as its object to completely or partially avoid the aforementioned disadvantages of the prior art, and to provide arrays of biomolecules which have a high density, whose individual binding regions are sufficiently spaced from neighboring binding regions, which can be used in optical analysis systems, may comprise addressable binding sites or which can utilize various functionalities. In particular, these arrays should be usable for single molecule analysis, in particular by using the SDT method, and they should meet the criteria required therefor. A further object of the present invention can also be seen in providing arrays which carry single molecules at defined, isolated positions and which can be read out by single molecule fluorescence microscopy. In particular, such single molecule arrays shall meet the aforementioned requirements for DNA arrays and enable a high throughput analysis of samples.

Accordingly, the present invention relates to an array for binding molecules, comprising functionalities capable of binding, which are provided on a solid carrier as molecular-single functionalities or in groups of the same functionalities, wherein the density of the individual functionalities, or of the groups of functionalities, respectively, on the solid carrier is from 10⁴ to 10¹⁰ single ones or grouped functionalities capable of binding, per cm², and with at least 95%, in particular with at least 99% of the single ones or grouped functionalities capable of binding, no further functionalities capable of binding are located within a chosen radial distance d from an (arbitrary) single functionality capable of binding, or group of functionalities capable of binding.

According to the invention, functionalities are always understood to be functionalities capable of binding, wherein according to the invention basically it makes no difference whether the groups capable of binding on the surface can form a covalent bond with a group capable of binding present on the partner molecule (from a sample, or with a linker, respectively) to be bound, or whether, e.g., only a bond can be realized which is based on electrostatic, ionic and/or hydrophobic interactions. Neither does it make any difference whether these binding properties are already “activated” or have yet to be specifically activated, e.g. in a conventional activating step. Therefore, by a functionality according to the present invention, a chemical group can be understood which either is chemically reactive or is made reactive by an activation. By reactive, any type of chemical or physical interaction is to be understood.

The arrays according to the invention are a decisively improved alternative to conventional microarrays, in particular, according to the invention densities of 1×10⁸ molecules or groups of alike molecules or more can be achieved. The minimum distance between molecules or groups of molecules of which a single resolution by fluorescence optical detection shall just be possible, is approximately equal to the wave length of the fluorescent light, ˜0.5 μm (diffraction limit of imaging optic microscopy). According to the invention, this basic limit in practice will determine the minimum distance between the molecules or groups of molecules to be ˜1 μm, i.e. in an area having the diameter of ˜1 μm around each molecule or each group of molecules, there should not be any further molecules. Nevertheless, the number of molecules or groups of molecules should be as high as possible, i.e. in most instances at least in the percent range of the preferred maximum area density of 1×10⁸/cm², so as to take advantage of the rapid data acquisition of the SDT scan method.

The present invention avoids the discussed disadvantages of the prior art and describes an array of single molecules on a solid substrate, wherein the position of the individual molecules is known from the start and the distance d between the individual molecules is larger than the optical resolution. The position of the individual molecules can be chosen and determined freely, just as is the distance between the molecules.

Thus, with the present invention densities can be achieved which are larger, e.g., than in WO 00/06770 A, by at least the factor 100; furthermore, the inventive array can be provided as an ordered array (as distinguished from the “random arrays” according to WO 00/06770 A and WO 98/39688 A. Finally, also different specificities of the binding sites can be provided and thus, multi-component arrays can be provided which, moreover, are even re-usable.

According to a preferred embodiment of the present invention, the distance d in the array is from 0.1 to 100 μm, in particular from 0.5 to 10 μm.

These distances allow for a particularly efficient utilization in the context of optical methods, particularly with SDT, in particular in the scan-mode according to WO 00/25113 A.

The array according to the invention preferably comprises additional units which are bound to the solid surface via functionalities capable of binding, wherein the units preferably are selected from the group consisting of nucleic acids, in particular RNA and DNA, as well as oligopeptides and polypeptides, in particular antibodies, or organic molecules, in particular members of a combinatorial library.

Preferably, in the array according to the invention, the density of the single ones or grouped functionalities capable of binding to the solid carrier is from 10⁵ to 10⁹, in particular from 10⁶ to 10⁸, single ones or grouped functionalities capable of binding, per cm².

Preferably, the solid surface is a glass, synthetic material, membrane, metal or metal oxide surface.

According to a preferred embodiment, the array according to the invention comprises additional units which are bound to the solid surface via the functionalities capable of binding, and to which additional molecules are, preferably non-covalently, bound.

According to a further aspect, the present invention relates to a method for producing an array for binding single molecules which is characterized by the following steps:
providing a solid surface with functionalities capable of binding,
contacting the solid surface with auxiliary structures that carry units, in particular organic groups, nucleic acids or polypeptides, which can bind to the functionalities capable of binding of the solid surface such that the auxiliary structures are bound to the solid surface via said units and functionalities,
treating said solid surface with said auxiliary structures bound thereto, with agents which either (i) inactivate said functionalities capable of binding which are not connected to said auxiliary structures so that these functionalities capable of binding lose their binding ability, or (ii) block the units which are not bound to said functionalities capable of binding of said solid surface,
treating said solid surface with the auxiliary structures bound thereto, with agents which split the bond between the auxiliary structures and the bound units or fragments of the bound units, and
detaching said auxiliary structures while leaving behind, in the region of the site of contact on said solid surface, said units or fragments thereof previously carried by the auxiliary structures.

Preferably, as said means for (i) inactivating the functionalities capable of binding and for (ii) blocking the units, chemical substances are employed which covalently bind to said functionalities capable of binding or to said units and thereby inactivate or block them. Examples are chemical substances having free thiol groups which can bind to functionalities capable of binding, such as maleimides.

As an alternative, this inventive method for producing an array for the binding of molecules can also be realized by the following steps:
providing a solid surface having functionalities and contacting the solid surface with auxiliary structures which carry units with activatable functionalities, which can bind to the functionalities of the solid surface if they are activated by external stimuli, or
providing a solid surface with activatable functionalities and contacting said solid surface with auxiliary structures that carry units with functionalities,
subjecting the solid surface with said auxiliary structures arranged thereon to an external stimulus so that the activated functionalities of the auxiliary structures or of the solid surface, respectively, will bind to the other functionalities of the solid surface or of the auxiliary structures, respectively, thereby binding the auxiliary structures to the solid surface via the units,
treating the solid surface with the auxiliary structures bound thereto, with agents which will split the bond between the auxiliary structures and the bound units or fragments of the bound units, and
detaching the auxiliary structures while leaving behind, in the region of the contact site on the solid surface, the units or fragments thereof previously carried by the auxiliary structures.

Both variants use one and the same idea of solving the problem in that a surface is specifically and locally defined activated, and deactivated, respectively, by means of auxiliary structures, thereby realizing the parameters of the arrays required according to the invention.

Preferably, external stimuli, such as electromagnetic waves in the form of UV light as well as changes in temperature, are used for activating the activatable functionalities.

Preferably, substantially spherical structures which consist of organic or inorganic polymers, metals or metal compounds are used as said auxiliary structures. As an example of a metal-containing auxiliary structure (bead) the products from Dynal (e.g., the product Talon) or BioMag® beads (microparticles with paramagnetic iron oxide core) can be cited (as an example among many others). The Dynabeads® TALON™ are uniform, super-paramagnetic polystyrene beads having a diameter of 1 μm, coupled with highly specific BD TALONT™ chemistry (tetradentate metal chelator in which 4 of the 6 coordinating sites are occupied by cobalt; the imidazole rings of histidine residues (in a polyhistidine peptide chain) they can occupy the two remaining coordinating sites, resulting in a protein bond).

To provide various specificities and to ensure addressability of the array, the auxiliary structures preferably have a label (or tag), wherein preferably more than one type of labeled auxiliary structure is used.

In this respect, it is particularly suitable if auxiliary structures having a fluorescence label are used, and it is preferred if auxiliary structures with different fluorescence labels are used.

Preferably, an arbitrary auxiliary structure carries only one specific type of units, such as organic groups, nucleic acids or polypeptides, wherein one population of auxiliary structures is used with differently occupied units each.

According to a preferred embodiment, in the method according to the invention both the specific fluorescence label of the different auxiliary structures and also the specific occupation of the auxiliary structures with units is known before the auxiliary structures are applied to the solid surface.

Because the positions of the fluorescence-labeled auxiliary structures on the solid surface is known, preferably the chemical identity of the units left behind by the auxiliary structures after detachment of the auxiliary structures is known.

Contacting of the solid surface with the auxiliary structures preferably is effected with the assistance of gravity, centrifugal force, magnetic force, electric attraction, enrichment on two-phase boundary layers or combinations thereof.

Preferably, a glass, synthetic material, membrane, metal or metal oxide surface is used as the solid surface.

Within the scope of the present invention, NH₂, SH, OH, COOH, Cl, Br, I, isothiocyanate, isocyanate, NHS-ester, sulfonyl-chloride, aldehyde, epoxide, carbonate, imidoester, anhydride, maleimide, acryloyl-aziridine, pyridyl-disulfide, diazoalkane, carbonyl-diimidazole, carbodiimide, disuccinimidyl-carbonate, hydrazine, diazonium, aryl-azide, benzophenone, diazirin-groups or combinations thereof have been found to be particularly preferred functionalities capable of binding.

Preferably, a spacer molecule can be provided between the functionalities capable of binding and the units to be bound, or between the solid surface and the functionalities capable of binding.

In a special embodiment of the method according to the invention, the following steps are used for producing an array for binding molecules:
providing a solid surface having functionalities capable of binding, preferably maleimide functionalities,
contacting the solid surface with auxiliary structures which have units, in particular nucleic acids or polypeptides, bound via molecular recognition, and which carry terminal thiol functionalities that can bind to the solid surface, so that the auxiliary structures are bound to the solid surface,
treating the solid surface with the auxiliary structures bound thereto, with thiol-containing reagents, preferably beta-mercaptoethanol, which inactivate the functionalities, in particular the maleimide functionalities, which are not linked to the auxiliary structures,
treating the solid surface with the auxiliary structures bound thereto, with a physical or chemical stimulus, in particular with increased temperature, which will reverse the molecular recognition between the auxiliary structures and the bound units, and
detaching the auxiliary structures while leaving behind, in the region of the site of contact on the solid surface, the units previously carried by the auxiliary structures.

According to a further special embodiment of the inventive method, the following steps are used for producing an array for the binding of molecules:
providing a solid surface having functionalities, in particular amines,
contacting the solid surface with auxiliary structures which carry units, in particular organic molecules of a combinatorial library, having activatable functionalities, in particular photo-activatable phenylazides, which can bind to the functionalities, in particular amine-functionalities, of the solid surface, if they are activated, in particular if activated by an illuminating step with UV light, wherein the units are bound to the auxiliary structures via chemically cleavable functionalities, in particular disulfide bonds,
subjecting the solid surface with the auxiliary structures bound thereto, to localized action of an external stimulus, in particular UV light, so that the units, in particular with the photo-activated phenylazides, will bind to the functionalities, in particular to the amine functionalities, and thereby the auxiliary structures will be bound to the solid surface, wherein the external stimulus, in particular in the form of an evanescent field of UV light, is employed and will have a localized effect on functionalities on the solid surface as well as on those parts of the auxiliary structures which are in the region of the evanescent field,
treating the solid surface with the auxiliary structures bound thereto, with agents, in particular dithiothreitol, that will cleave the disulfide bonds present between the auxiliary structures and the bound units or fragments of the bound units,
detaching the auxiliary structures while leaving behind, in the region of the site of contact on the solid surface, the units or fragments thereof previously carried by the auxiliary structures.

Naturally, the invention also relates to arrays obtainable according to the method of the invention.

In another aspect of the invention, the arrays according to the invention are used within the scope of a fluorescence-microscopical examination (primarily for single molecule investigations), in particular for the single dye tracing (SDT) method.

In particular, the arrays according to the invention can be used for binding biomolecules, in particular for the binding of antigens, ligands, proteins, DNA, mRNA, toxins, viruses, bacteria, cells or combinations thereof, and then all the methods possible with these arrays (e.g. detection and analysis methods) can be carried out.

Furthermore, the arrays of the invention are used for assaying cDNA of cells, wherein fluorescence-labeled cDNAs will bind to the array of different oligonucleotides, and the binding can be read out for each bound cDNA-type.

The arrays according to the invention preferably are also used for assaying proteins of cells, wherein fluorescence-labeled proteins will bind to the array of different antibodies and the binding can be read out for each bound protein-type.

The realization of a free area of a diameter of 1 μm around each “binding place” (single “capture molecule” or a group of equal “capture molecules”) with areal densities of the “binding places” in the range of preferably 10⁶ to 10⁸/cm² constitutes a preferred embodiment of the present invention.

A further particularity of preferred inventive arrays is the realization of the addressability of the binding places. For the advised applications, the position and the number of binding places should be known as precisely as possible and a priori, as should be the type of molecule on each binding place. Such an addressability of the binding places with regard to both the position and the function (specific molecular recognition of an analyte molecule) is the key to a simple and also broad application. For the inventive array with antibodies and oligonucleotides, e.g., it is known against which protein which antibody is directed at which location, and which oligonucleotide will hybridize with which DNA or messenger-RNA sequence to which site of the matrix. Without an addressability, no interrelationship can be established between the observations made at a binding site and the type of the molecule bound. A molecule-specific conclusion would not be possible, and thus the central advantage of applying single molecule microscopy to the tasks described would be missing.

Via the addressability, samples of many different biomolecules can be decyphered by labeling with just one fluorescence marker because the fluorescence detection at a certain location means a bond to a certain capture molecule. Without functional addressability, the analyte molecules would either have to be labeled individually and measured sequentially, or many different dyes would have to be used simultaneously for a color-specific labeling, which either would be unfeasible or would meet practical limits very quickly.

By the addressability, not only access to information is facilitated, but also the computing time for data acquisition and evaluation is shifted to an acceptable range. In fact, without prior knowledge of just the positions of the binding sites, the computing time with fast computers and fast algorithms would take a long time, since the required search for the molecule positions (maximums of the single molecule fluorescence intensity) of ˜10⁸ molecules requires intensive computation.

The requirements forming the basis of the invention for realizing a molecule matrix (abbreviated as MARS, matrix of addressable recognition sites, hereinafter) can be summarized as follows:

The binding sites for molecular recognition (capture molecules, single or in groups of the same) should be present on MARS preferably in the following manner in combinations:
1. isolatedly detectable (no molecules within a radius of at least ˜0.5 μm around binding site)
2. position of each binding site shall be known a priori
3. function of each binding site shall be known a priori
4. density of different addressable binding sites shall be high (10⁶ to 10⁸/cm²)

Accordingly, the invention particularly relates to the manufacture of matrices of organic molecules or biomolecules (e.g. antibodies, receptors, peptides, oligonucleotides or nucleic acids) which are transferred and bound to the surface of a substrate via suitable auxiliary structures, such that the transferred biomolecules will be present in isolated form individually or in groups of equal molecules, i.e. can be observed in isolated form by means of optic single molecule microscopy. Both, the position and also the type of each single biomolecule or each isolated group of equal molecules is known a priori, wherein the mean areal density of the bound molecules is to reach very high levels. Use of these addressable molecule matrices serves for quantifying the specific binding (molecular recognition) of binding partners (e.g. antigens, ligands, proteins, DNA, messenger-RNA, toxins, viruses, bacteria, cells etc.) by employing fluorescence labeling of the binding partners and a new, patented microscopic method (“single dye tracing, SDT”) which enables reading of these molecule matrices with high sensitivity (imaging down to individual fluorescence molecules) and, at the same time, a very high speed.

In the following, preferred realizations of the arrays according to the invention will be described by way of embodiments schematically illustrated in the drawing figures.

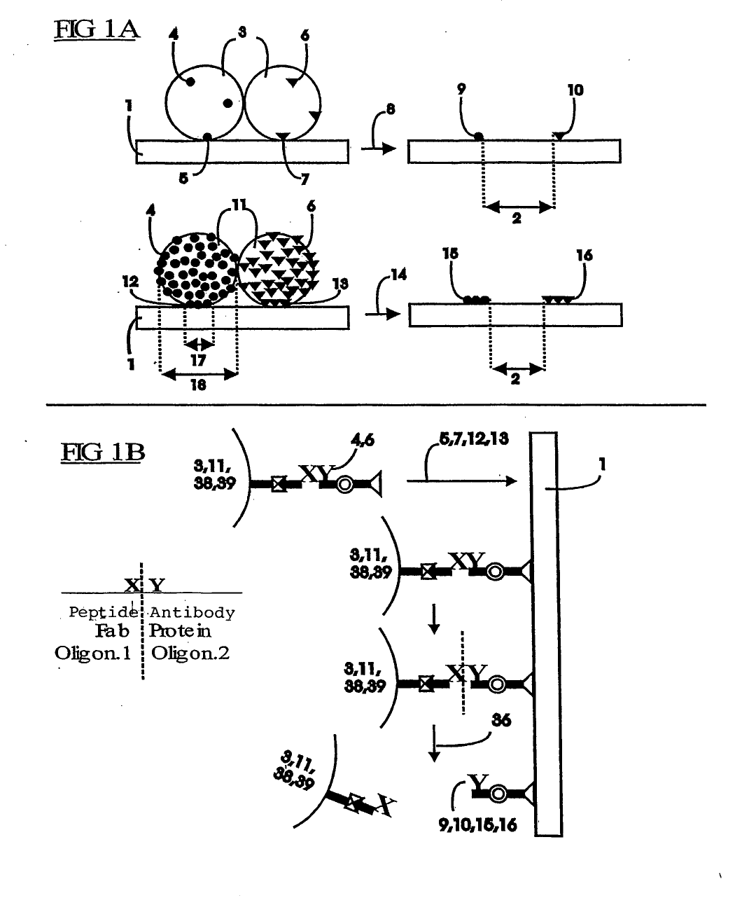

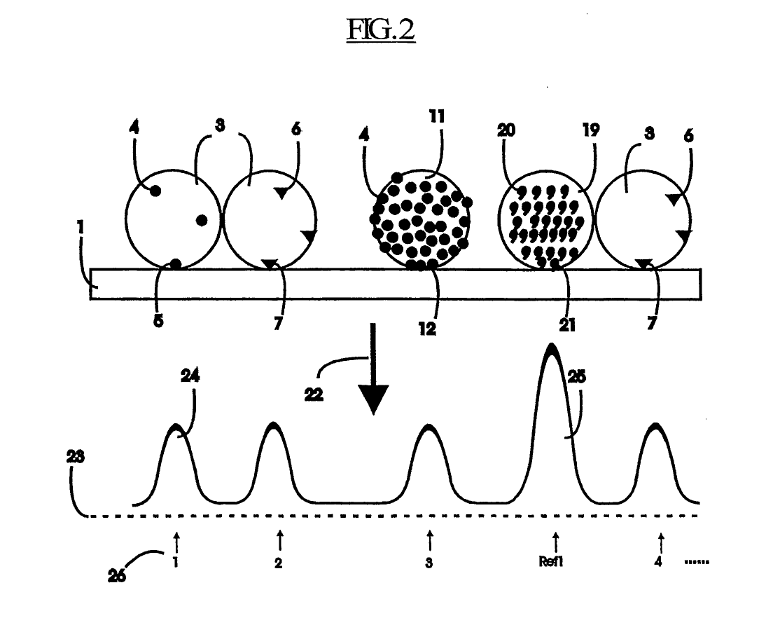

To meet the objects set out according to the invention, preferably auxiliary structures can be used (FIG. 1A), in particular beads (3, 11) of organic or inorganic substances having diameters (18) which will be a function of their purpose of use and range between ˜0.5 to ˜100 μm. Each bead (3, 11) carries “capture molecules” (4, 6), of one type each. By adding the beads to a substrate (1), the “capture molecules” (5, 7, 12, 13) get in contact with the substrate surface, and a controlled transfer (8, 14) of “capture molecules” (5, 7, 12, 13) from the beads (3, 11) to the substrate surface is rendered possible such that binding sites (individual ones or groups of equal “capture molecules”) will form which are spatially separated from each other (9, 10, 15, 16).

FIG. 1B outlines the individual steps of the transferring procedure by way of example at a transferred “capture molecule”. The “capture molecules” (e.g. antibodies, oligonucleotides, etc.; symbol Y in FIG. 1B) are bound to the beads, preferably via molecular recognition by complementary biomolecules (e.g. epitopes for antibodies, complementary oligonucleotides etc.; symbol X in FIG. 1B), which are bound to the surface of the bead either directly or via flexible spacer molecules. The beads are preferably added in liquid phase to the substrate and will adhere to its surface. Under suitable conditions, a hexagonal dense packing can be achieved. Their unspecific interaction with the substrate is weak in comparison with the specific binding of the “capture molecules”. The capture molecules (4, 6) bind (FIG. 1B: 5, 7, 12, 13), covalently or via specific, non-covalent molecular interaction, to the surface of the substrate (1). The binding strength of a “capture molecule” suffices to retain the bead at the binding site. After fixing “capture molecules” to the substrate, the beads are removed from the surface (36), and the “capture molecules” are left behind at the site of contact to the bead on the substrate (9, 10, 15, 16). When detaching the beads, the molecular recognition complexes between the transferred “capture molecules” and the complementary molecules bound to the beads become dissociated. The bonds of the molecular recognition can be detached easily and without damage to the “capture molecules” by choosing specific conditions of the liquid phase, and without the fixing of the “capture molecules” being reversed by the substrate. Other methods for detachment are the application of tensile forces (when using magnetic beads (Edelstein et al., 2000)) or hydrodynamic shearing forces.

The “imprints” left behind by the beads are either single “capture molecules” (FIGS. 1A, 9, 10), when using beads of correspondingly low occupation density (3), or groups of M “capture molecules” (FIGS. 1A, 15, 16), when using beads with a correspondingly high density of bound “capture molecules” (11). In both instances, the minimum distance of the binding sites (2) is given by the diameter of the beads (18), reduced by the diameter of the binding region (17). The obtainable density of binding sites corresponds to the density of the transfer-beads, which can reach a hexagonal dense packing. However, by the addition of beads and their incidental binding via “capture molecules”, the maximum density is not reached, yet approximately 25% of the maximum density can be achieved easily, which is a sufficiently high density for all applications. For instance, with d=1 μm beads, approximately 30 million binding sites will be transferred at this density per cm² (provided normal area of the molecule matrix).

The number of “capture molecules” transferred per “imprint” depends on several factors and can be controlled in this manner. Two important factors are the areal density of the “capture molecules” on the bead as well as the binding capacity of the substrate relative to the “capture molecules”. In addition, the number of the transferred “capture molecules” is also influenced by the size of the area of contact (FIG. 1A: 17) between bead (11) and substrate (1). A larger area of contact results when using substrates which are occupied by a compressable polymer layer. When using a coating by means of linear flexible polymer chains, the radius r of the area of contact (17) can be calculated from the diameter d (18) of the bead, and the effective polymer length h, with the relationship r²˜h*d. For the flexible spacer molecule PEG (polyethylene-glycol), Mw=2000, with a maximum stretched length of 15 nm, a dynamic length range of h=5-10 nm results from values measured for its flexibility (Jeppesen et al., 2001). For a bead having a diameter (18) of d=1 μm, this gives a binding region (17) with the radius r=70-100 nm. Beads having a high occupation density (11), M “capture molecules” per r², will then allow for the transfer of approximately M “capture molecules”. M is adjustable within a wide range with established methods for occupying beads with biomolecules via molecular recognition, with densities up to 1/50 nm². Thus, for instance, with a bead with d=1 μm, a group of M “capture molecules” can be transferred which is adjustable between M=1 and M˜200, with a statistical deviation of M^{1/2}.

For transferring (FIG. 1A: 8) individual “capture molecules” (9, 10), beads sparsely occupied by “capture molecules” (3) are employed. The reliability of a single molecule transfer can well be estimated for experimentally controllable conditions. The mean number of “capture molecules” on the bead be <N>. With low values of <N>, a random distribution can be assumed, both of the number N of the “capture molecules” on individual beads (Poisson distribution with mean value <N> and of the distribution of the N “capture molecules” on the surface of each bead, the probability of finding M of the N “capture molecules” in the area of contact by binominal distribution being described. Without any further assumptions, this will give a formula for estimating the error probability that in the area of contact more than one “capture molecule” is bound: P (>1)=(<N>*(r/d)²)². For <N>=3, a bead diameter (18) d=1 μm, and a diameter (17) of the effective area of contact for binding of 2r=200 nm (conservative value, see above) is P (>1)≦0.0009, i.e. each 1000^{th} bead, at the most, transmits two “capture molecules”. The fact that, statistically, on each ˜20^{th} bead there will be no “capture molecule” has no essential influence on the result (slight reduction of the mean density of the binding sites). For an even more sparing occupation of the beads, for instance for <N>=1, the reliability of the transfer of individual “capture molecules” will increase (each 10000^{th} binding site, at the most, will carry two “capture molecules”), yet also the portion of beads without “capture molecules” rises to −37%.

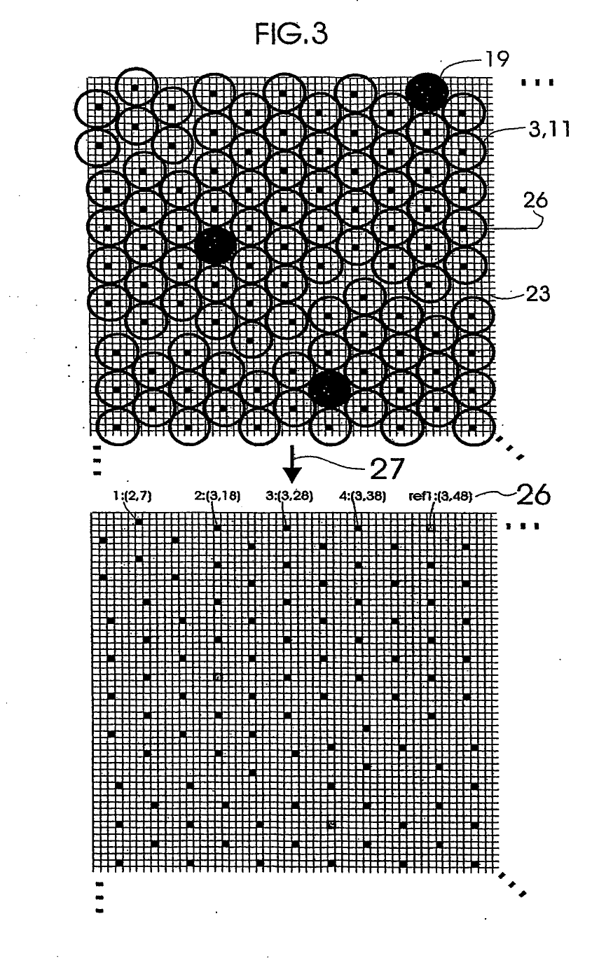

To determine the position of the imprints of the transferred “capture molecules” on the substrate, the positions of the beads are measured before they are detached (FIG. 2: 22). Also for this the use of the SDT scan method is advantageous. When using fluorescent beads, the position of each bead can be determined with very high precision from its image (24) on the pixel array (23) of the CCD (charged coupled device) camera used in the SDT method, at about 40 nm (Hesse et al., 2002). For practical applications, the less precise allocation of individual pixels to each bead will suffice (FIG. 2: 26, as well as FIG. 3: 26), whereby the limiting time of the data evaluation is substantially shortened, approximately to the time of the data acquisition. Besides the beads which are used for producing binding sites, the matrix also contains beads that serve as position references (FIG. 2: 19 and FIG. 3: 19). These beads carry reactive functionalities (FIG. 2: 20) in high density and are fixed to the substrate via several covalent or non-covalent bonds (FIG. 2: 21) and cannot be detached any longer. They are fluorescent and give a significantly greater signal (FIG. 2: 25) on the pixel array (FIG. 2: 23). After the detachment of the transfer beads, the reference beads remain on the substrate and their positions (FIG. 2: REF 1) yield a long-lived grid for finding again (FIG. 3: 27) the positions of the binding sites (FIG. 3: 26). The SDT scan method allows each position of a surface covered by merely 0.1% with randomly distributed reference beads, to be found again with a precision of far below one pixel, even after an intermediate removal of the matrix from the SDT scan microscope.

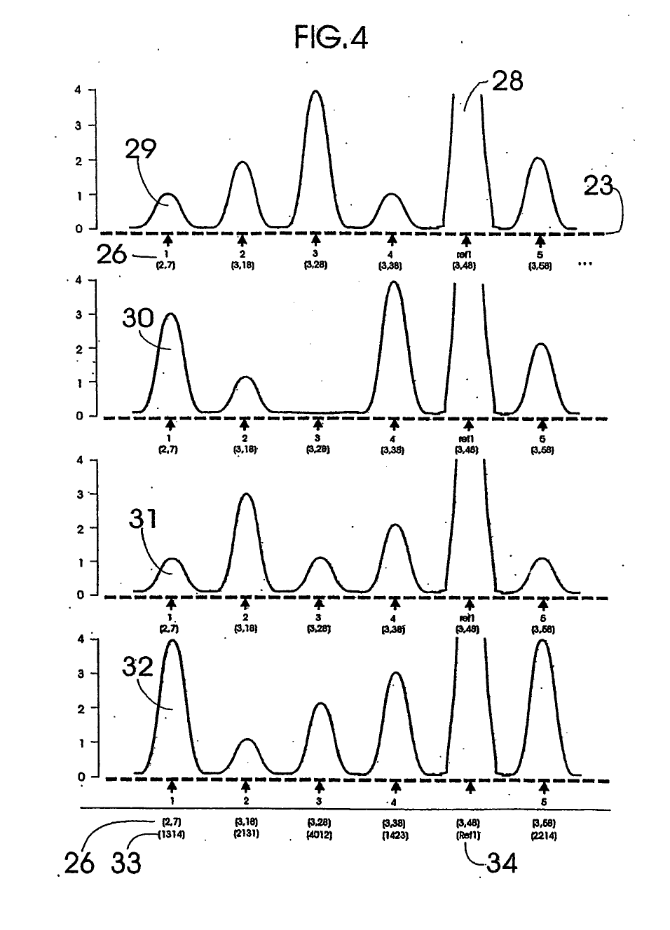

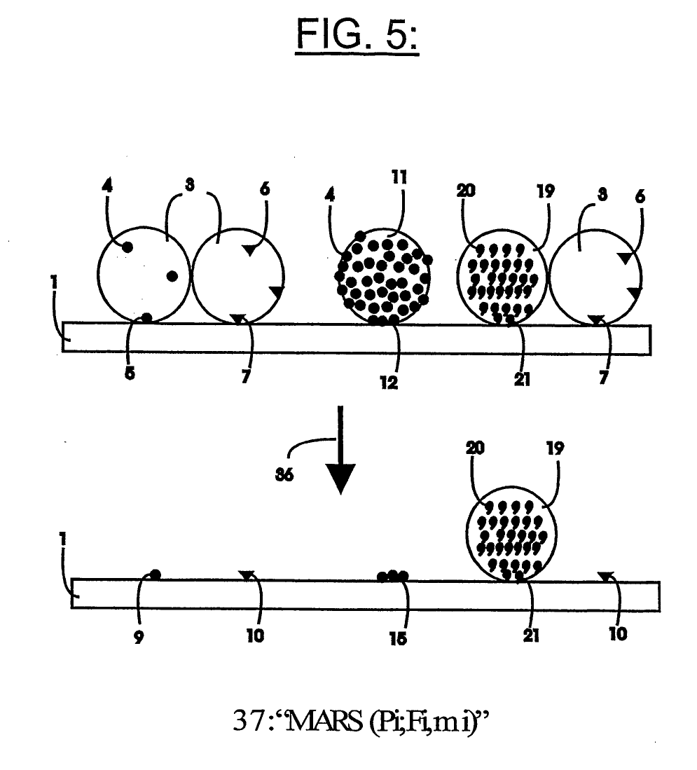

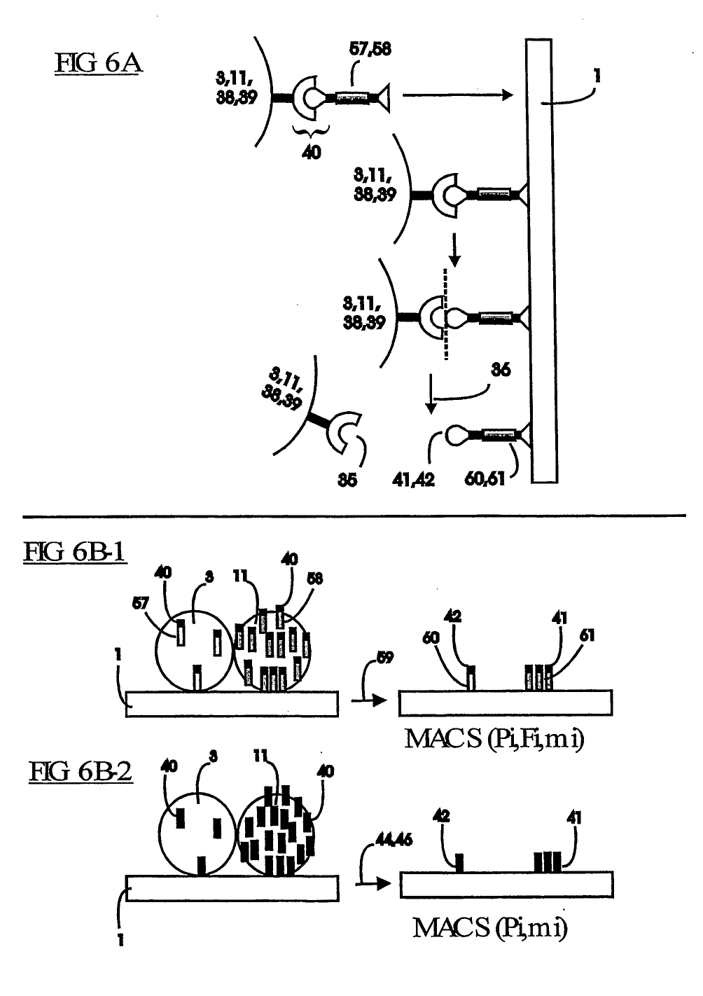

For realization of the functional addressability (a priori association of type and number of “capture molecules” with the binding sites), color coding of the beads is used (FIG. 4). Color coding of beads of inorganic or organic polymers of the size in question is prior art and is offered in a few variants by companies (Bangs, Luminex, Microparticles, micromod, dynal). There, fluorescent molecules of various colors are provided in the beads, it being possible to adjust the numbers of the molecules of each color to definedly regraded values. With n different colors and m different concentrations of each fluorophore, in principle mⁿ−1 beads of distinguishable fluorescence can be produced. By binding certain “capture molecules” to beads having a certain color code, a color code (33, 34) is measured for each binding site (FIG. 4: 26) via fluorescence measurement of the bound beads, which color code indicates which “capture molecule” is present at that binding site. Due to the extreme sensitivity of the SDT method, beads can be precisely measured with regard to the grading of their fluorescence intensity and with regard to their positions. In FIG. 4, this is outlined for five grades 0, 1, 2, 3 and 4 (up to 10 grades are commercially available for the same die) of fluorescence of four different dyes. For each dye, the fluorescence image of the spherical matrix (FIG. 4) is separately recorded. For each bead position (FIG. 4: 26), this will give one color code (33), for instance 1314 for the bead at site 2, 7, determined from the four different fluorescence intensities (29, 30, 31, 32) for these beads. With the 4 dyes and the 5 grades, 5⁴−1=624 different beads can be distinguished. The optical resolution of the SDT scan method will probably allow for the distinguishing of libraries with thousands of different color code beads, wherein, however, the provision of such large libraries will require substantial technical expenditures. For each bead of the matrix, the pixel position and the color code including that of the reference beads (34) with high fluorescence intensities (28) is stored. This data set serves for identifying the binding sites within the matrix after detachment (FIG. 5: 36) of the transfer beads. The 1 cm² sized matrix (FIG. 5: 37) of binding sites and reference beads having a diameter of 1 μm together with the stored positions Pi of all the binding sites, i=1 to ˜30 millions, and their functions (type of “capture molecule”, Fi and number of “capture molecules”, mi, at site i) be denoted by “MARS(Pi;Fi,mi)”, “MARS” being the abbreviation of “matrix of addressable recognition sites”.

Besides the production of a biochemical matrix of addressable recognition sites, “MARS”, the use of beads for transferring molecules also allows for the production of the chemical analogue, a matrix of addressable chemical reaction sites, “MACS” in short. In contrast to MARS, in the production of MACS the detachment of the beads is not effected by dissociation of complementary biochemical binding partners, such as oligonucleotides, but by the chemical cleavage of a covalent bond. FIG. 6A shows the steps occurring during the production of a MACS on a molecule by way of example. The molecules to be transferred are bound to the beads and are assembled of a functionality (40) which can be cleaved (e.g., a disulfide bond), an optional molecule portion (57, 58) as well as a terminal functionality. Following the addition, the beads adsorb to the substrate and, via the terminal functionalities, bind to the surface of the latter. For detachment of the beads, the functionalities (40) which can be cleaved are separated (e.g. reduction of the disulfide by means of dithiothreitol); a portion of the cleaved functionality (41, 42) (thiol, e.g.) as well as the optional molecule portion (60, 61) will remain on the substrate (1).

MACS molecule matrices can be prepared via the route described here for two different tasks: In the first instance (FIG. 6B-1), the purpose is to transfer a population of different molecules (57, 58) from beads (3, 11) to the planar substrate (59). The molecules, which are each different, are provided either individually (60) or in groups (61) in the matrix MACS (Pi;Fi,mi), Pi being the position, Fi the molecule type and mi the number of molecules for the binding sites, i=1 to 30 million. One example of a specific application is a combinatorial library of organic substances on beads (Jung, 2000; Nicolaou et al., 2002). One bead carries only one type each of an organic substance, and the entirety of the different substances is to be transferred to a planar substrate so as to be able to test their biological activity. In order not to disturb the evaluation, the cleaved functionalities (41, 42 in FIG. 6A and FIG. 6B-1; thiol, e.g.,) can be inactivated (methyl iodide).

In the other instance (FIG. 6B-2), a chemical matrix is produced with identical, cleaved, reactive functionalities (41, 42) (thiol, e.g.,) on a surface. The chemical functionalities can be further modified chemically, such as with antibodies or oligonucleotides. In general, this chemical matrix can be described by MACS(Pi;mi), the number mi of reactive functionalities being present at position Pi.

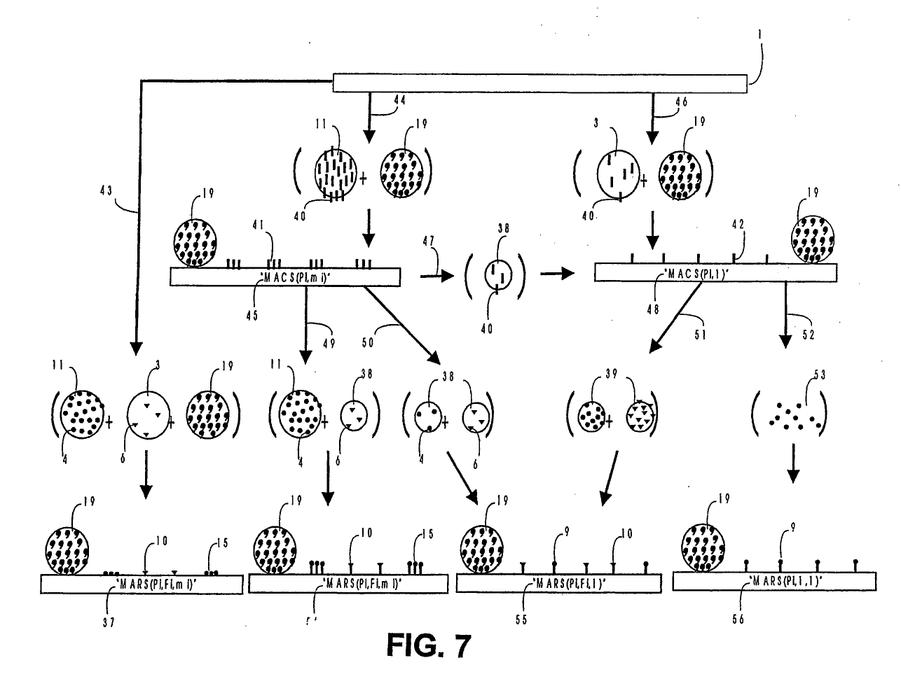

FIG. 7 sums up some routes in which “matrices of addressable chemical reaction sites of the last mentioned type MACS(Pi,mi) (FIG. 6B-2) can be produced and then transferred in MARS (matrices of addressable recognition sites). Starting out with the substrate (1), the functionalities (40) of beads (11, 3) with high or low occupation density are transferred to the substrate surface via the transfer step (44, 46). The resultant matrices contain isolated sites with groups of reactive functionalities (41), MACS (Pi,mi) (45) or sites with individual reactive functionalities (42), MACS (Pi,1) (48). Chemical matrix MACS (Pi,mi) (45) can also be converted (47) to MACS (Pi,1) (48) by employing smaller beads (38) with very few reactive functionalities (40). This has the advantage of being able to produce highly pure matrices with individual reactive functionalities (42). This is achieved by the cyclic repetition of the binding of the smaller beads (38) with functionalities (40) (e.g. ortho-pyridylsulfide) to a few of the reactive functionalities (41) (thiol, e.g.), which thereby are protected from the subsequent inactivation of the free functionalities on the substrate (1), by N-ethyl-maleimide, e.g. With this route (47), no substantial reduction of the areal density of the reactive sites (42) will occur. Of course, the same method may also be directly used on the matrix “MACS(Pi, 1)” (48) (not included in FIG. 7) so as to purify the matrix from error sites having more than one reactive functionality.

The resultant chemical matrices (45, 48) are universally applicable and can be used for producing “MARS” matrices of various types. Some examples are illustrated. Route (51): The production of multi-functional single molecule matrices, “MARS(Pi;Fi,1)” (55) is facilitated in that the loading of the beads, advantageously small beads (39) with a large number of “capture molecules” (4, 6) is not critical with regard to the areal density of the “capture molecules” on the beads, since for the binding thereof to the substrate surface, per binding site only one reactive group is available on the substrate. Route (50): Alternative route for producing “MARS(Pi;Fi,1)” (55) by using small beads (38) loaded with few “capture molecules” (4,6). Route (52): Matrices with only one type of “capture molecules”, “MARS(Pi;1,1)” (56) can be produced directly by the addition of “capture molecules” into the liquid phase (53). Route (49) is a possible way for the production of matrices “MARS(Pi;Fi,mi)” (54) with single ones or groups of “capture molecules”. Route (49) starts out from matrix MACS(Pi,mi) (45) and is an alternative to the direct route (43) for producing “MARS(Pi;Fi,mi)” matrices without chemical matrices.

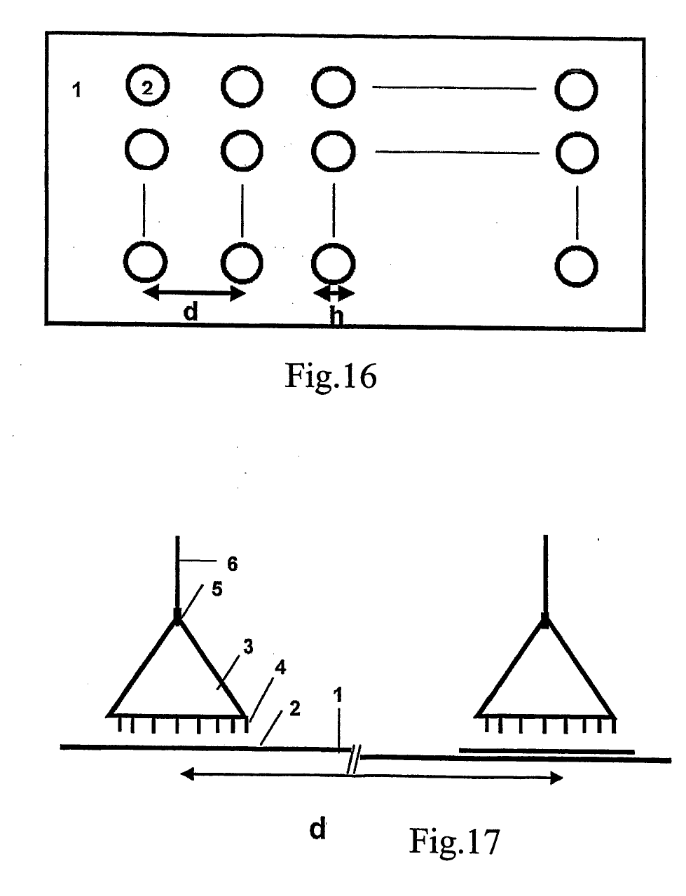

According to another preferred embodiment, the inventive array is assembled of two components, a surface with nanoscopic islands and an adapter bound to this island. The first component is a solid substrate with a nano-structured surface (FIG. 16). Nano-structuring consists in the form of islands of nanoscopic dimensions (FIG. 16, 2) which are applied to the solid substrate (FIG. 16; 1) and are distinguished from the surrounding, chemically unchanged surface by their different chemical composition. The material of which the islands are composed must be capable of interacting with the solid surface to which it is applied in a manner that the island will remain tightly and lastingly connected to the solid surface. Moreover, after application to the surface, the islands must remain localized and must not change in their expansion (apart from slightly atomically diffusing off and slight thermal effects). After having been deposited on the surface, the spatial dimension of the islands therefore must remain constant, in particular also in measurement processes during the subsequent use. The material of the islands also is chosen as a function of the solvent to be used; in the solvent chosen, the material should be inert, e.g. relative to oxidation.

The material of which the nanoscopic islands consist is chosen such that the islands will be adapter-specific, which means that the adapters will specifically bind to the islands, yet not to the solid surface, nor to the substrate between the islands, respectively. The size of the islands is adjustable by the process of production, and their dimension can suitably range from 1 to 100 nm. Especially preferably, the size of the islands will be “tailored” to the adapters used, so that it can be ensured that an adapter molecule will completely cover an island. Smaller islands, however, have the disadvantage that their shape, or the constancy of their spatial dimension, respectively, will be difficult to ensure, since with such excessively small islands, the properties of the respective material may in part change dramatically. Excessively large islands (i.e. excessively large adapters) are detrimental with regard to their exact localization in the detection experiment. Therefore, according to the invention, nanoscopic islands having a spatial dimension (diameter on the solid substrate) of from 3 to 70 nm, preferably from 5 to 50 nm, in particular from 10 to 30 nm, have proved particularly suitable. Irrespective thereof, the distance between a molecule portion bound to the functionality and excitable by light, in particular a fluorophore, and the nanoscopic islands is from 0.1 to 100 nm, preferably 1 to 50 nm, in particular 5 to 30 nm.

The material of which the inventive nanoscopic islands are made is preferably chosen from the group consisting of metals, inorganic or organic materials, in particular metal oxides, short-chain organic molecules, organic polymers and silane reagents. According to the invention, preferred metals are primarily gold and silver, but also copper, zinc, lead, palladium and platinum. In principle, more noble metals are preferred over other ones because they are inert with regard to oxidation, in particular in oxygen from air or water (metals which are resistant to oxidation relative to oxygen from water and/or air). Preferred inorganic materials are metal oxides, in particular copper oxide, tantalum oxide, titanium oxide, and semiconductor structures, in particular quantum dots of CdSe, ZnSe or InGaAs. Preferred short-chain organic molecules are 16-mercaptohexadecanoic acid and 16-hydroxyhexadecanoic acid-hydroxamic acid; preferred organic polymers are poly-L-lysine, poly-L-glutamate or biotin-polyethylene-glycol-poly-L-lysine; preferred silane reagents are mercapto-methyl-dimethylethoxysilane, 3-mercaptopropyl-triethoxysilane, 16-bromo-hexanedecan-trichlorosilane, 3-aminopropyl-triethoxysilane and 3-glycidoxypropyl-trimethoxysilane.

Preferably, the materials of which the islands are composed are also chosen on account of their suitability in certain application methods. Materials whose basic suitability in one or several of the application methods (spotting) is known in the prior art are therefore deemed to be preferred in any case.

According to this preferred embodiment of the array according to the invention, the second component consists of adapters which bind single molecules, biomolecules, e.g., such as single DNA strands, to the islands. An adapter usable according to the invention (FIG. 17; 3) has two functional parts. (i) The first part (FIG. 17; 4) which reacts with the islands, yet not with the regions between the islands, has the effect that the adapters bind only to the islands, yet not to the regions between the islands. (ii) The second part (FIG. 17; 5) has a binding capacity by means of which a certain single molecule, in particular a biomolecule (FIG. 17; 6) is bound to the adapter, and thus to the islands on the surface of the solid substrate. What is essential is that only specific (bio)molecules are bound to the adapter, i.e. that the adapter has a specific binding site for a specific molecule which will then only bind to the adapter, yet not to the solid surface or to the island material. The adapters may preferably have a single binding specificity; in other instances, the objective may also require the provision of several, mutually different or of several equal specific binding sites (e.g. 2, 3 or 4 sites; in any event, always only a certain number which has been determined a priori) in the adapter molecule. A further feature of the adapters is that the two parts are arranged on different sides of the adapter, so that the adapter will bind to the island with its one side (FIG. 17; 4), while the binding capacity of the other adapter side (FIG. 17; 5) for single molecules, in particular biomolecules, will not be negatively affected. A third feature of the adapters is that their (along the normal line to the solid surface) projected 2-dimensional size is at least equal to the size of the islands, or may also surpass the latter, respectively. This will ensure that only one adapter has bound to a biomolecule per island. If the adapters were much smaller than the islands, several adapters and biomolecules could bind to a single island, and the single molecule array would no longer be ensured, so that these embodiments as a rule represent only less favorable embodiments of the present invention.

Preferably, the methods already established in the prior art and proven to be useful are used in the production of the array according to the invention. Accordingly, the following methods therefore will be preferred for applying the nanoscopic islands to the surface of the solid substrate: With the dip-pen nanolitography (DPN) (Lee at al., 2002), an atomic force microscopy tip wetted with molecules is positioned above the substrate, and by putting down the tip, the molecules are deposited on the surface. With the scanning tunneling microscopy (STM), a—for instance, gold-coated—AFM tip is held above the surface to be structured, and by applying a voltage between AFM tip and substrate, a part of the metal is transferred from the AFM-tip to the surface of the substrate (Kolb et al., 1997; Mamin et al., 1990). With the electron beam lithography (EBL), a sensitive lacquer layer on a surface is inscribed with an electron beam (Chen and Pepin, 2001; Chen et al., 1998) so as to obtain relief structures which will yield the respective islands on the substrate after gold vapor deposition and lift-off. With the micro-contact printing (μCP) (Bernard et al., 1998; Whitesides et al., 2001), molecules are transferred to the substrate by printing with an elastic polymer replica.

Preferably, the solid surface is a glass, synthetic material, membrane, metal or metal oxide surface which, preferably, is plane, smooth and impermeable (e.g. to the solvent or to a sample buffer).

According to the preferred embodiment of the invention, the islands consist of metal, metal oxide, organic or inorganic polymers, as well as groups of organic or inorganic compounds.

Preferably, the adapters are of a metallic, inorganic, organic or biochemical nature. For a metallic adapter, according to a preferred embodiment, gold or silver cluster or nanogold (or nanosilver) derivatives (Boisset et al., 1994), in particular such having only one functionality, are used, to which a single DNA strand will be bound.

According to a preferred embodiment, dendrons, also termed “molecular wedges”, are employed as the organic adapters. The tip of the dendron core consists of a single functionality to which a biomolecule is coupled, while the periphery of the dendron, i.e. the other end of the dendron, consists of a plurality of equal functionalities which bind to the island (Bell et al., 2003). WO97/39041 as well as Zhang (Zhang et al., 2000; Zhang et al., 2001) describe the undirected binding of dendrimers to surfaces, without positioning of the dendron being guided by an organizing principle.

According to a preferred embodiment, DNA dendrimers or, preferably, proteins are used as the biochemical adapters. Proteins are suitable to be used as adapters for two types of reasons. Proteins or defined protein-multimers have a maximum extension of up to 100 nm, and thus have a size comparable to the nanostructured islands so that multiple occupation of the islands by several adapters is rendered difficult. The use of proteins as adapters is preferred because when knowing their three-dimensional structure, changes in their protein structure can purposefully be made by means of mutagenesis methods, so that subsequently a directed coupling of a single biomolecule to the adapter is effected, while not interfering with the interactions between the adapter and the islands.

Preferably, binding of the adapters or of the single molecules to the adapters to the islands is by covalent coupling, electrostatic interaction, ligand complexes, biomolecular recognition, chemisorption or combinations thereof. For covalent coupling, preferably, the following functionalities are used: NH₂, SH, OH, COOH, Cl, Br, I, isothiocyanate, isocyanate, NHS-ester, sulfonyl-chloride, aldehyde, epoxide, carbonate, imidoester, anhydride, maleimide, acryloyl-aziridine, pyridyl-disulfide, diazoalkane, carbonyl-diimidazole, carbodiimide, disuccinimidyl-carbonate, hydrazine, diazonium, aryl-azide, benzophenone, diazirin groups or combinations thereof. For biomolecular recognition, preferably biotin-Streptavidin, antibody-antigen, DNA-DNA interactions, sugar-lectin or combinations thereof are used.

According to a preferred embodiment, the present invention relates to a method for producing the array of single molecules, which is characterized by the following steps:
applying nanoscopic islands to the surface of a solid substrate by surface structuring methods, in particular by means of STM, DPN, EBL, ion beam lithography or micro-contact printing
applying adapters to the nanoscopic islands,
coupling single molecules to the adapters bound to the nanoscopic islands,
saturating unoccupied islands possibly present, by variants of adapters which do not carry any molecules.

As an alternative, this inventive method for producing an array of single molecules can also be accomplished by the following steps:
applying nanoscopic islands to the surface of a solid substrate by surface structuring methods, in particular by means of STM, DPN, EBL or ion beam lithography or micro-contact printing
coupling molecules to adapters in solution,
separating non-coupled adapters, or non-coupled molecules, respectively, by purification steps,
applying said adapters coupled to the single molecules to the solid substrate structured with nanoscopic islands.

In a particular embodiment of the method according to the invention, the production of an array of single molecules is achieved by the following steps:
applying nanoscopic islands, preferably gold dots, to the surface of a solid substrate of glass, by scanning tunneling microscopy,
applying adapters, in particular dendrons, to the islands, in particular to the gold dots, wherein a dendron carries non-activated disulfide groups on its periphery which bind to an island, in particular to a gold dot, and the dendron core carries a single functionality, in particular an N-hydroxy-succinimide functionality, which can couple to the amine functionality of a single molecule, in particular of a modified DNA oligonucleotide,
coupling the single molecules to the adapters, in particular by reaction of the amine functionality of the DNA oligonucleotides to the N-hydroxy functionality of the dendrons that have bound to the nanoscopic islands, in particular to gold dots,
removing those adapters and single molecules which have not bound to the nanoscopic islands, in particular by washing.

In another particular embodiment of the method according to the invention, the production of an array of single molecules is achieved by the following steps:
applying nanoscopic islands, in particular gold dots, to the surface of the solid substrate of glass by scanning tunneling microscopy,
coupling the single molecules to adapters in solution, in particular by reaction of the amine functionality of the DNA oligonucleotides, to the single functionality of the dendron core, in particular an N-hydroxy-succinimide functionality,
purifying the adapter-single molecule-conjugates, in particular the dendron-DNA-conjugates, and removing the non-coupled single molecules or non-coupled adapters by purification methods, in particular by gel permeation chromatography,
applying the adapter-single molecule-conjugates to the nanoscopic islands, in particular to gold dots, wherein a dendron on the periphery carries non-activated disulfide groups which bind to a nanoscopic island,
removing those adapter-single molecule-conjugates which have not bound to the nanoscopic islands, in particular by washing.

The invention also relates to arrays obtainable by the method according to the invention.

Reading-out of the inventive array of isolated molecules is effected by methods of single molecule microscopy and single molecule fluorescence microscopy, in particular by the method according to WO 00/25113 A.

The presence of metallic islands does not negatively interfere with the reading-out of the single molecule fluorescence signals, but surprisingly, the frequency of the detection of fluorescence photons is even increased by the vicinity of the specifically bound fluorophore to the nanoscopic metallic islands (Enderlein, 2000; Geddes and Lakowicz, 2002; Geddes et al., 2003a; Geddes et al., 2003b; Lakowicz, 2001, Lakowicz et al., 2002).

Preferably, the arrays of the invention can be used for investigating biomolecules, in particular oligonucleotides, DNA, mRNA, cDNA, proteins, antibodies, antigens, ligands, toxins and employed for their detection and investigation by means of detection methods.

Preferably, the arrays according to the invention can be employed for binding other biomolecules, in particular oligonucleotides, DNA, mRNA, cDNA, proteins, antibodies, antigens, ligands, toxins, viruses, bacteria, cells or combinations thereof, and used for their detection and investigation by means of detection methods.

As outlined in FIG. 17, following the surface structuring of the substrate, the nanoscopic islands are occupied by adapters. The adapters (FIG. 17: 3) are the binding member between the nanoscopic islands (FIG. 17: 2) and the target molecules (FIG. 17: 6) which are coupled in the array to the substrate (FIG. 17: 1). In accordance with their function, the adapters have both a functionality (FIG. 17: 5) with which they can bind the target molecules, and also a group of further functional units (FIG. 17: 4) with which the adapters can bind to the nanostructured islands (FIG. 17: 2). The chemical nature of the functionalities of the adapters and that of the interaction between adapter and molecule, and between adapter and nanoscopic island, may be covalent or non-covalent, and is highly specific, i.e. the adapters can bind only to the nanoscopic islands, yet not to the regions of the substrate between the nanoscopic islands; furthermore, the molecules can only bind to the adapters, yet not to the nanoscopic islands or to the regions between the islands.

The adapters may be assembled of organic, inorganic or biochemical polymers as well as metals. In a preferred embodiment, the adapters consist of an organic polymer, such as the wedge-shaped dendrons, which are composed of dihydroxybenzyl alcohol units, or of other backbone units. Coupling of the dendrons to the nanoscopic islands of gold may, e.g., be based on the stable thiol-gold interaction, if dendrons with a plurality of thiol or disulfide groups are used. Coupling of the adapters to the nanoscopic islands can be achieved by adding a solution of adapters to the substrate, followed by washing steps so as to remove from the substrate any excess of adapters which have not bound to the nanoscopic islands. In a further step, the single molecules are coupled to the substrate-bound dendrons. Thus, the molecules can carry a single amine functionality which can bind to the single functionality of the dendrons, by employing N-hydroxysuccinimide-chemistry, e.g. Molecules in excess which are not coupled to adapters can be removed by the most varying methods known in the prior art, in particular by washing with suitable purifying liquids.

In another preferred embodiment, the adapters consist of an inorganic polymer, such as glass, and have spherical shapes. In this case, the coupling of the spherical adapters to the nanoscopic islands can be effected in that gold islands are modified with thiol-containing reagents, such as N-(6-(biotin-amidohexyl)-3′-(2′-pyridyldithio)-propionamide (biotin-HPDP), and the latter are occupied by Streptavidin-coated adapters. Prior to or after anchoring to the solid substrate, the Streptavidin-coated adapters can be contacted with a solution of molecules in order that single molecules will come to lie on the gold islands.

The size of the adapters can be chosen freely and will be adapted to the diameter of the nanoscopic islands such that only one adapter can bind per nanoscopic island. For producing an array with single molecules, various types of adapters may simultaneously be used; preferably, an arrangement with only one type of adapter is realized.

The invention will be explained in more detail by way of the following Examples (and the drawing figures), to which, of course, it is not limited.

Therein,

FIG. 1: (A) shows a schematic illustration of the procedure in which single ones or groups of molecules are transferred to a planar substrate by means of spherical auxiliary structures. (B) shows a schematic illustration of the individual steps of the procedure for transferring biomolecules with a “capture molecule” by way of example;

FIG. 2 shows a schematic illustration of beads adsorbed to a planar substrate, the fluorescence intensity of the beads being determined by scanning;

FIG. 3 shows a schematic illustration of the method for unambiguously determining the positions of fluorescent beads by way of an array of pixels;

FIG. 4 shows a schematic illustration of the fluorescence images of surface-localized and color-coded beads which contain different fluorophores at different concentrations.

FIG. 5 shows a schematic illustration for producing a matrix of addressable recognition sites, “MARS”.

FIG. 6 shows a schematic illustration of the procedure for producing a matrix of addressable chemical reaction sites, “MACS”, by means of spherical auxiliary structures. (A) Representation of the individual steps of the procedure for producing a MACS with a molecule by way of example. (B) shows a schematic representation of the production of two different types of MACS;

FIG. 7 shows a schematic illustration of various routes for converting matrices of addressable chemical reaction sites to matrices of addressable recognition sites.

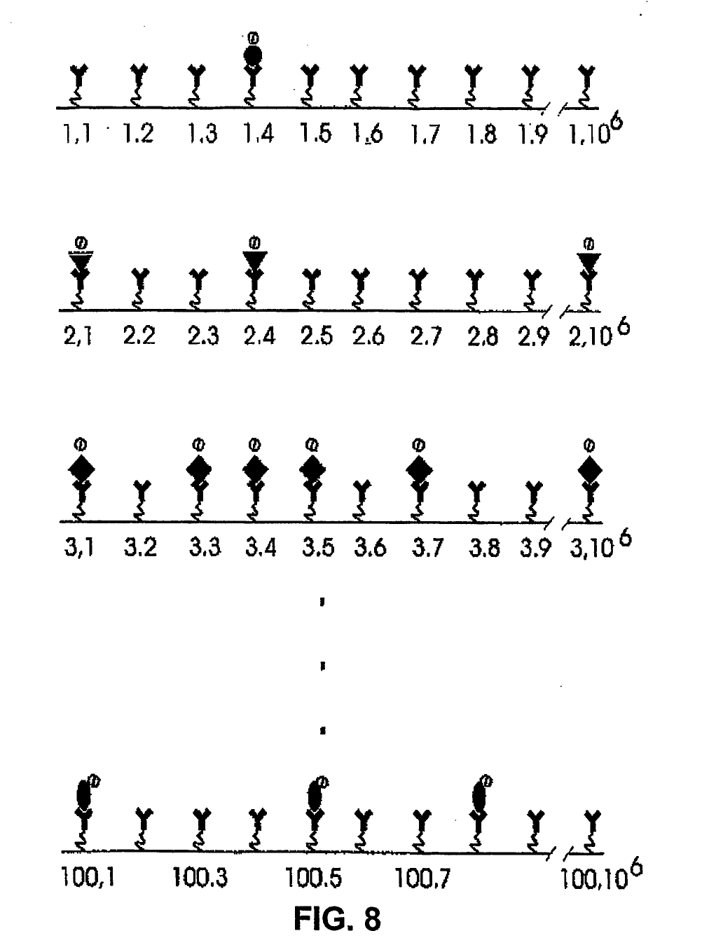

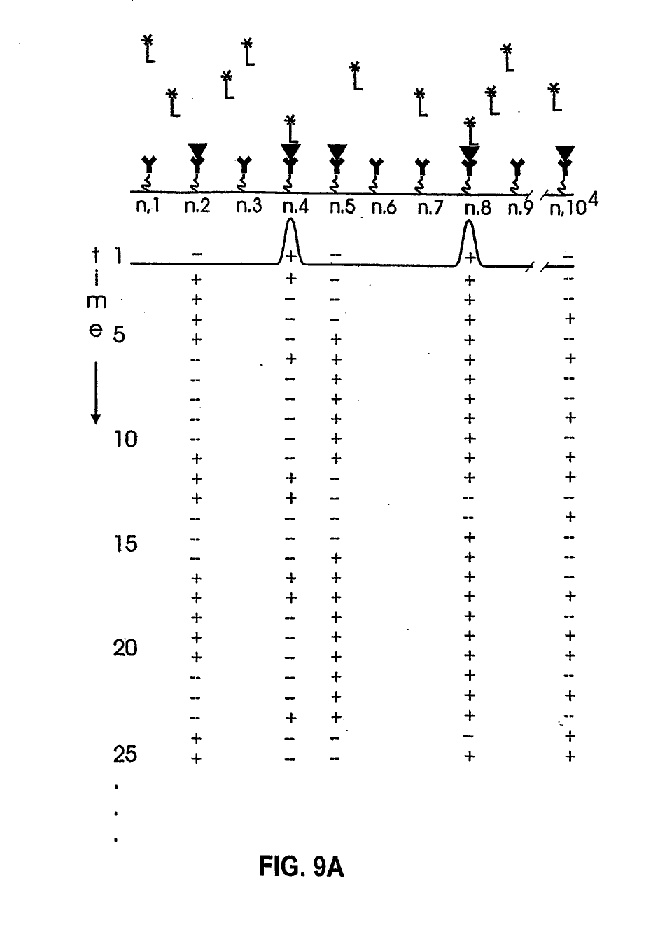

FIG. 8 shows applications for MARS matrices: utilization of the high sensitivity.

The large extent of the matrix “MARS(Pi;Fi,1)” of ˜10⁸ binding sites allows for many different “capture molecules” (here, 100 different antibodies by way of example; also mixtures of oligonucleotides and antibodies may be employed) to be offered, at the same time providing each “capture molecule” in many copies (here 1 million), from which, with the detection sensitivity of single fluorescence molecules, there results a dynamic range for the detection of 6 orders of magnitude, and this at the same time for the detection of 100 different biomolecules, measurable by SDT-scan in ˜5 min.

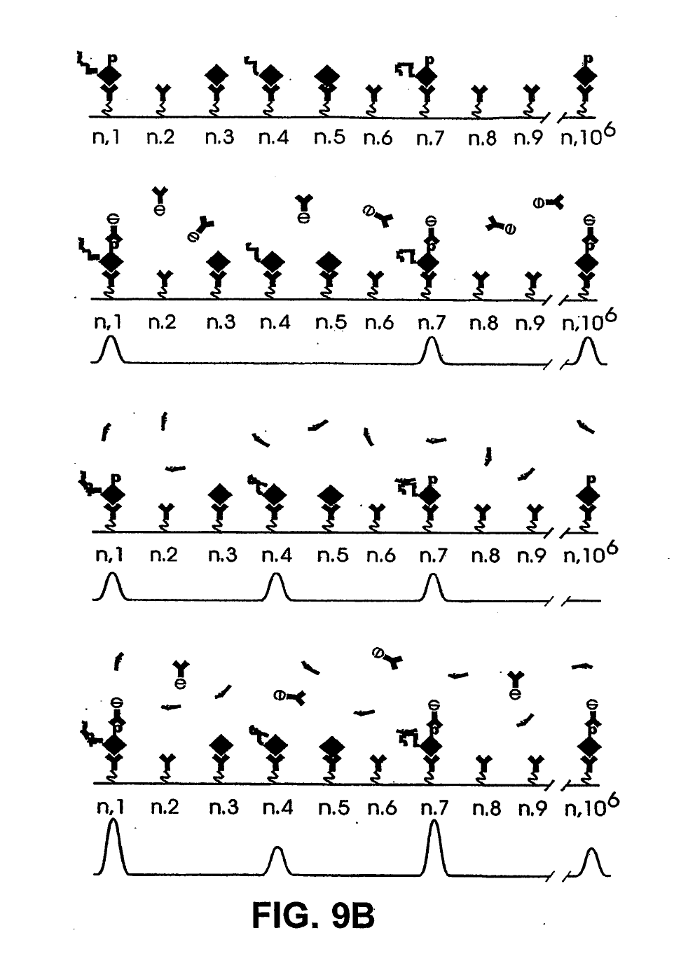

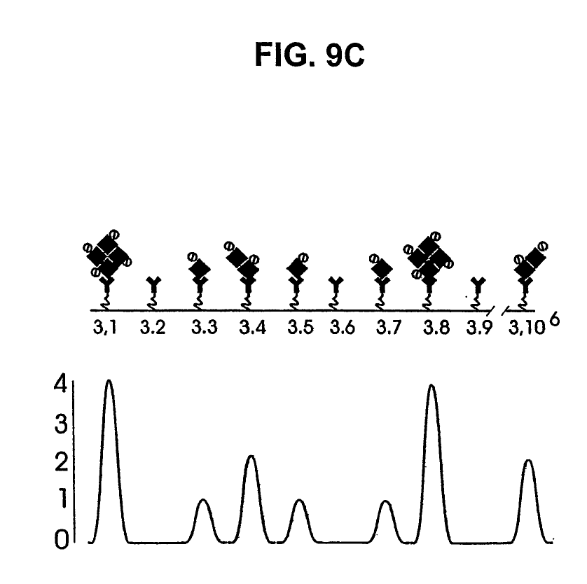

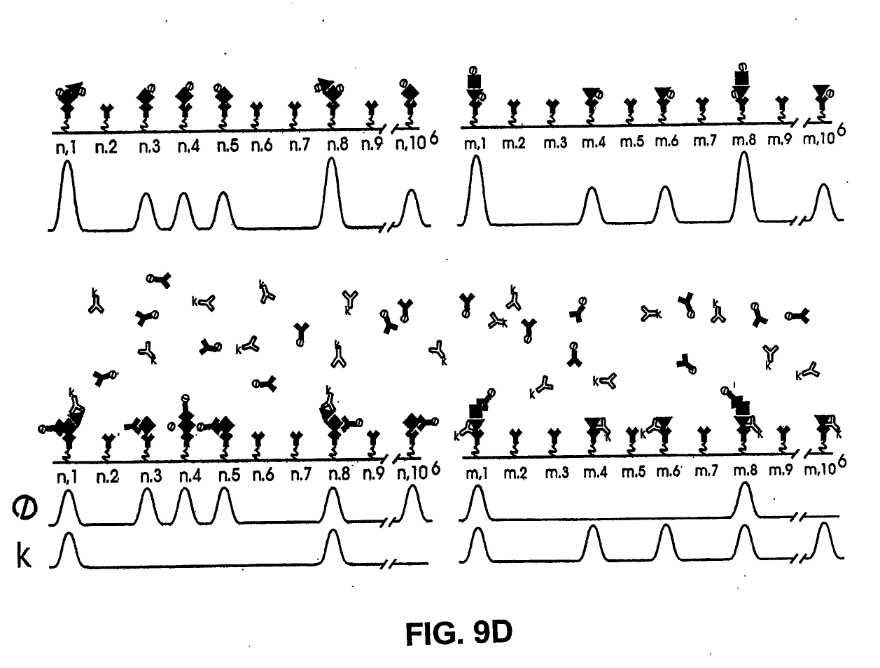

FIG. 9 shows uses for MARS matrices: proteomics;

FIG. 9A shows uses for MARS matrices: protein function. Simultaneous measurement of the function of many (10⁴ in this case) single proteins (triangles) by repeatedly capturing images, for registering the ligands (L) bound at the respective time which carry a fluorescence label (asterisk). In the preferred embodiment, the ligands in solution yield a negligible fluorescence background. The application to enzymes is particularly promising. The functional answers (series of +, binding and −, no binding) indirectly give the binding constants and the association and dissociation constants for the ligand binding of each individual one of the 10⁴ receptor molecules or enzymes, thus allowing for the direct measurement of the function variability of biomolecules. The SDT scan method allows for 10⁴ molecules at a distance of ˜1 μm to be taken in 50 ms so that the function of the proteins occurs with a temporal resolution of ˜50 ms;

FIG. 9B shows applications for MARS matrices: measurement of the post-translational modification of proteins. By using fluorescence-labeled antibodies to phosphorylation sites (P) and of labeled lectins against sugar residues on the proteins, the profile of these modifications can be measured for one protein or for several proteins, and optionally can be put into a structure-function-correlation with the previously measured variation of the function (FIG. 9A);

FIGS. 9C & D show uses for MARS matrices: measurement of protein associations. Here the fact that the SDT method allows for stoichiometric measurements of co-localized fluorescence molecules is made use of. The intensity at the binding sites provides an information on the homo-association (FIG. 9C) or hetero-association (FIG. 9D). For the latter one, it is shown in the lower part of the image that the same information independently can be obtained or checked and ensured by using two different dyes;

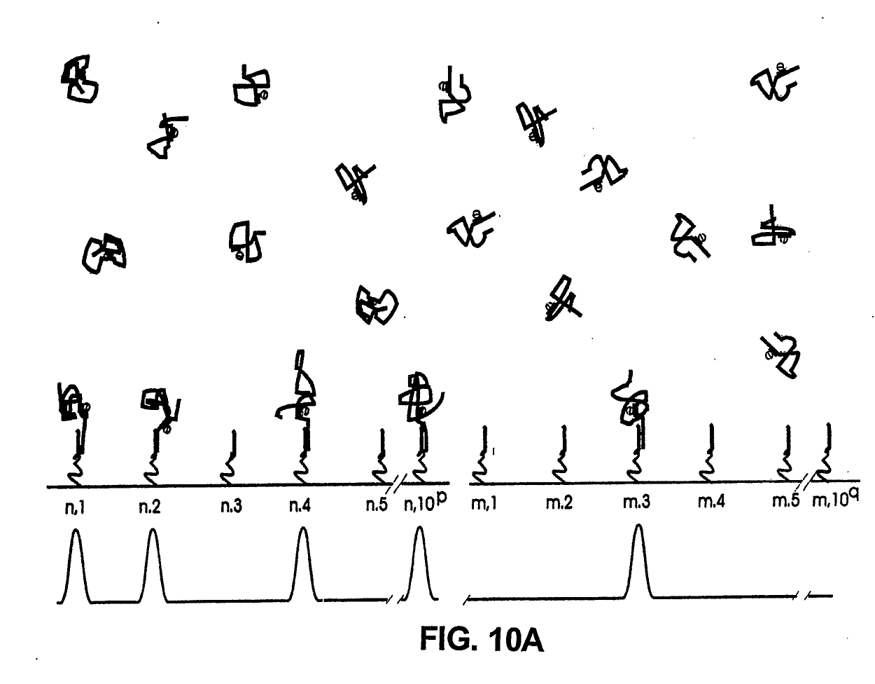

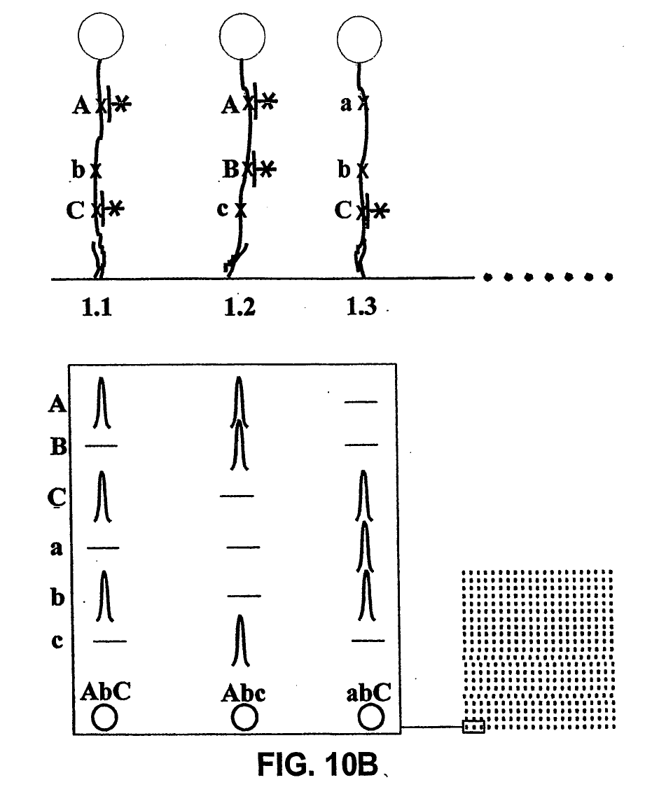

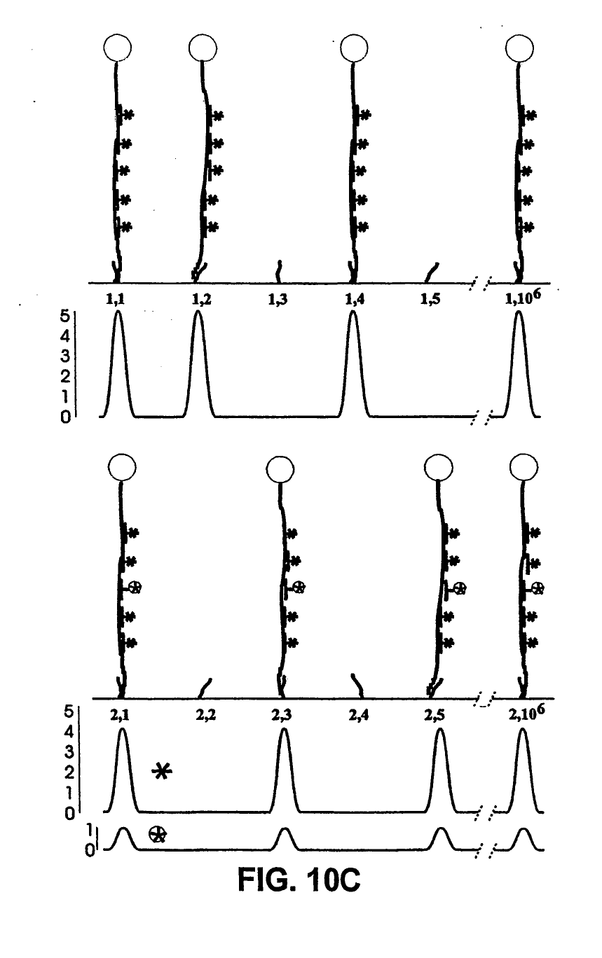

FIG. 10 shows uses for MARS matrices: DNA and mRNA analyses.

FIG. 10A shows uses for MARS matrices: measurement of mRNA-profiles. A matrix having numerous different oligonucleoties, yet each one in sufficiently high numbers for ensuring a high sensitivity, can be employed to provide mRNA profiles of, e.g., extracts from cells or organelles for different states of the cells.

FIG. 10B shows uses for MARS matrices: correlation of neighboring SNPs. At present, there is a great interest in determining the successive arrangement of SNPs (single nucleotide polymorphism) in certain regions of the genome. The DNA single strands in question at first are fixed with one end thereof to magnetic beads, and the other end thereof is fixed to corresponding oligonucleotides on the matrix. By using magnetic force, the DNA strands are stretched so that the binding of fluorescence labeled oligonucleotides to the SNP sites to be examined will be as secure as possible. The fluorescence response by the SDT scan will then provide an information on the simultaneously occurring mutations on the SNP sites;

FIG. 10C shows uses for MARS matrices: mutations in “repeats”. The same method as in FIG. 10B can be used for identifying mutations in the region of DNA with multiple-repeating sequences (“repeats”), by using two different oligonucleotides: one against the natural sequence, and one against the mutant sequence. The upper image half shows the result for DNA without mutation, the lower one with a mutation;

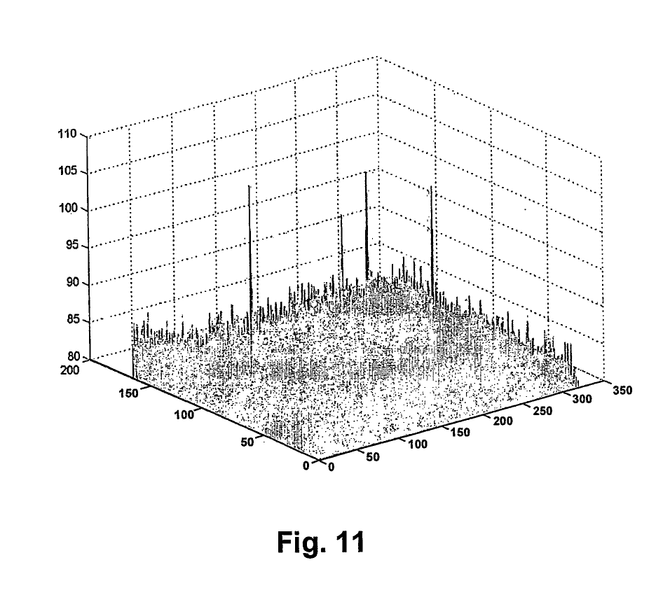

FIG. 11 shows a figure ad Example 1: visualization of single fluorophores by means of the SDT scan method;

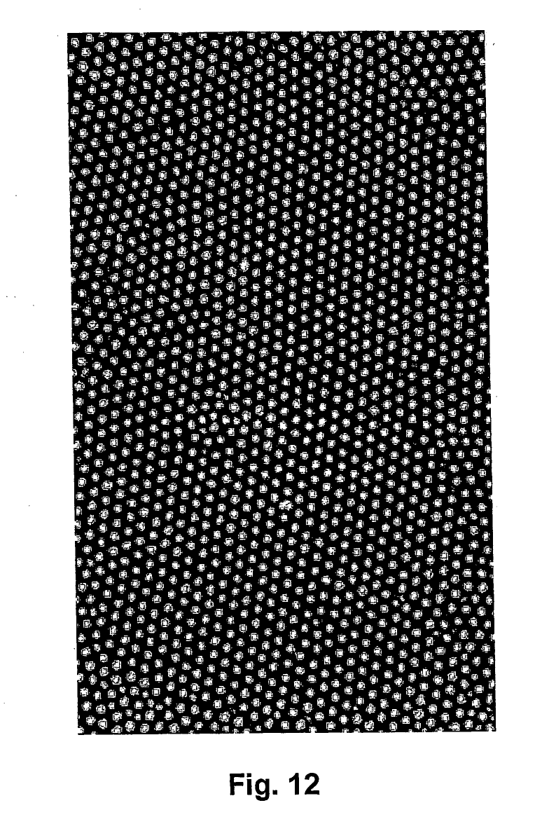

FIG. 12 shows a figure ad Example 2: hexagonal dense packing of beads on a surface;

FIG. 13 shows a figure ad Example 3: detachment of labeling beads. A: labeling beads denoted by arrows before (A) and after detachment (B) of non-coupled beads;

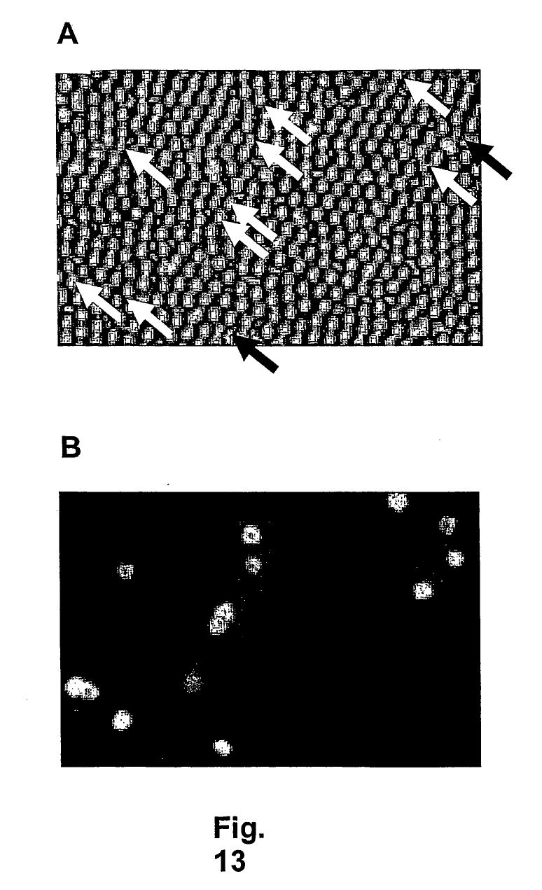

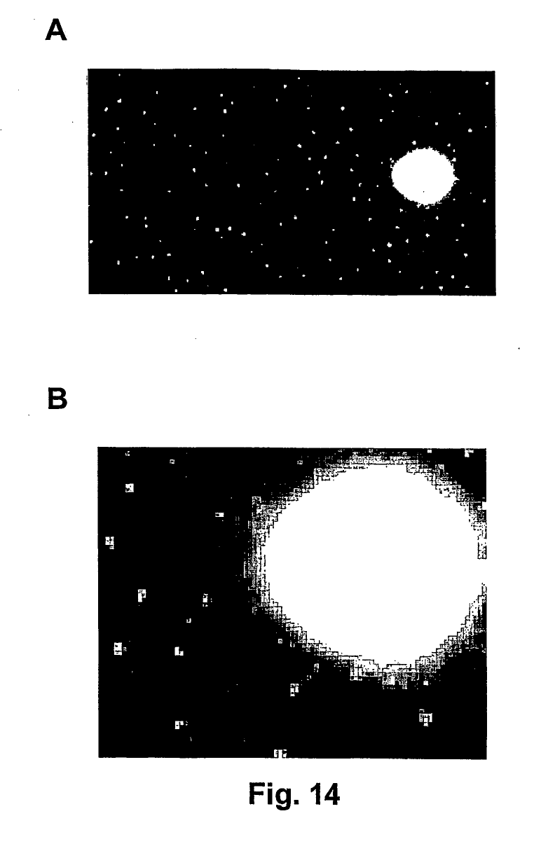

FIG. 14 shows a figure ad Example 4: imprint of groups of fluorescence-labeled molecules which have been transferred to a planar surface and covalently bound;

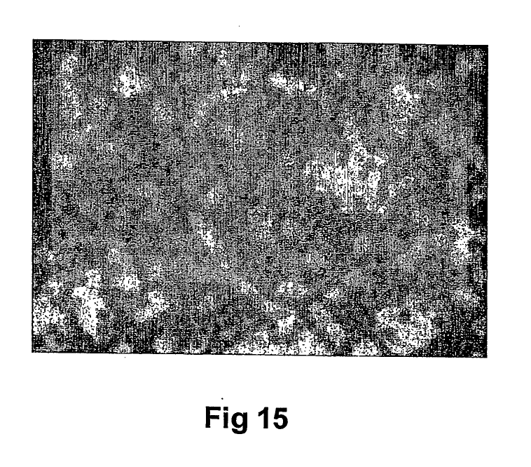

FIG. 15 shows a figure ad Example 5: beads arranged on a surface and having different fluorescence labeling;

FIG. 16 shows a schematic illustration of an arrangement of nanoscopic islands (2) applied to a solid substrate (1). The mean distance d between the nanoscopic islands and the diameter h of the nanoscopic islands can be freely selected by the surface structuring method. The array consists of an arbitrary number of nanoscopic islands;

FIG. 17 shows a schematic illustration of an array of individual molecules, seen in side view. A single molecule (6) is bound to an adapter (3) via a functionality (5). With its other side (4), the adapter (3) binds to a nanoscopic island (2) that is bound to the surface of a solid carrier (1). The mean distance between two nanoscopic islands, the adapters and, thus, between the single molecules, is given by d. For reasons of clarity, only two nanoscopic islands with the adapters are shown; the array consists of any number of islands, adapters and molecules;

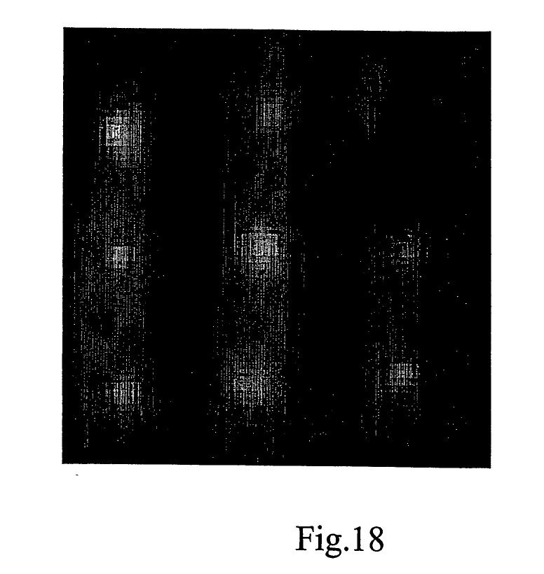

FIG. 18 shows a figure ad Example 6. Binding of spherical adapters to nanoscopic gold islands. For producing the arrays, preferably solid substrates can be used which, by means of a surface structuring method, have been provided with a regular grid consisting of nanoscopic islands (FIG. 16). The nanoscopic islands (FIG. 16: 2) preferably consist of a metal, such as gold or silver, and are applied by direct deposition of the metal, such as by STM, at regular intervals on the solid substrate (FIG. 16: 1), preferably an electrically conductive substrate, such as indium-tin oxide-glass. In another preferred embodiment, the nanoscopic islands of metal are deposited on the substrate during an electric beam lithographic process. The diameter of the nanoscopic islands, h, will be a function of the particular purpose of use and will preferably be in a range of from 5 to 50 nm (FIG. 16). The vertical height of the nanoscopic islands will depend on the type of surface structuring method and, with STM, may amount to 1-5 nm, with EBL it will be in a range of from 3 to 5 nm. The nanoscopic islands are spatially separated from each other, and the mean distance d between two islands can be freely selected by the surface structuring method and will be above the diffraction limit of the optic microscopy.

Index of denotations in FIGS. 1-7:

1. Substrate

2. Minimum distance of transferred molecules on substrate

3. Bead for transfer, occupied by a few capture molecules

4. Capture molecule of defined type, for transfer, bound to bead by molecular recognition

5. Capture molecule (4) fixed to the substrate, prior to detachment of the bead

6. Capture molecule of defined type, for transfer, bound to bead by molecular recognition, capture molecule different from 4

7. Capture molecule (6) fixed to substrate, prior to detachment of the bead

8. PROCEDURE: transfer of single capture molecules

9. Transferred single capture molecules (4) after detachment of the bead

10. Transferred single capture molecules (6) after detachment of the bead

11. Bead for transfer, occupied by many capture molecules

12. Capture molecules (group of 4) fixed to substrate, prior to detachment of the bead

13. Capture molecules (group of 6) fixed to substrate, prior to detachment of the bead

14. PROCEDURE: transfer of several capture molecules (groups)

15. Transferred groups of capture molecules (4) after detachment of the bead

16. Transferred groups of capture molecules (6) after detachment of the bead

17. Binding region on contacting area bead-substrate

18. Diameter of a bead for transfer

19. Reference bead

20. Reactive groups in high density on reference bead

21. Reactive groups (20) from reference bead, “covalently bound” to substrate

22. PROCEDURE: Scanning of beads prior to the detachment

23. Pixel array

24. Image of beads for transfer to pixel array

25. Image of reference beads on pixel array

26. Position of the binding sites, defined by position of the beads imaged on pixel array

27. PROCEDURE: re-locating the positions

28. Fluorescence intensity of the reference bead

29. Fluorescence intensity of a defined bead for transfer, within a chosen range of wave length

30. Fluorescence intensity of a defined bead for transfer, within a range of wave length differing from 29

31. Fluorescence intensity of a defined bead for transfer, within a range of wave length differing from 29 and 30

32. Fluorescence intensity of a defined bead for transfer, within a range of wave length differing from 29, 30 and 31

33. Color code (with random values)

34. Color code of reference bead

35. Portion remaining on beads after cleavage of functionality 40

36. PROCEDURE: detachment of beads for transfer

37. Matrix of binding sites and reference beads, MARS (matrix of addressable recognition sites) or MARS (Pi,Fi,Mi)

38. Small beads for transfer, occupied by few molecules

39. Small beads for transfer, occupied by many capture molecules

40. Reactive cleavable functionalities for producing MACS (matrix of addressable chemical reaction sites)

41. Transferred groups of reactive functionalities on MACS

42. Transferred single reactive functionalities on MACS

43. PROCEDURE for producing MARS (Pi,Fi,mi) (37)

44. PROCEDURE for producing MACS (Pi,mi) (45)

45. MACS with groups of equal functionalities, MACS (Pi, mi)

46. PROCEDURE for producing MACS (Pi, 1) (48)

47. PROCEDURE for conversion of MACS (Pi,mi) (45) into MACS (Pi, 1) (48)

48. MACS with individual sites of equal functionalities, MACS (Pi, 1)

49. PROCEDURE for converting MACS (Pi,mi) (45) into MARS (Pi,Fi,mi) (54)

50. PROCEDURE for converting MACS (Pi,mi) (45) into MARS (Pi,Fi,1) (55)

51. PROCEDURE for converting MACS (Pi,1) (48) into MACS (Pi,Fi,1) (55)

52. PROCEDURE for converting MACS (Pi,1) (48) into MACS (Pi,1,1) (56)

53. Capture molecules in liquid phase

54. MARS (Pi,Fi,mi) with single ones and groups on different capture molecules of different types, produced from MACS (Pi,mi) (45)

55. MARS (Pi,Fi,1) with exclusively single capture molecules of different types, produced from MACS (Pi,mi) (45) and MACS (Pi,1) (48)

56. MARS (Pi,1,1) with exclusively single capture molecules of same type, produced from MACS (Pi,1) (48)

57. Molecule of defined type for transfer, bound to bead

58. Molecule of defined type of transfer, bound to bead; molecule different from 57

59. PROCEDURE: transfer of molecules individually and/or in groups

60. Transferred single molecule

61. Transferred group of molecules

### EXAMPLES

### Example 1

Single Cy3 fluorophores were immobilized on a glass platelet and visualized by SDT-scan. For an immobilization, Cy3 at first was coupled to polyethyleneglycol-diamine, and this conjugate was covalently bound to an epoxide surface via the remaining terminal amine group of the PEG. To produce the Cy3-PEG-conjugate, 0.2 grams (100 mmol) of PEG-diamine (Mw 2000, Rapp Polymere) were dissolved in 4 ml of hydrochloric acid-containing dimethyl-formamide (DMF) pH=6.5, and incubated for 3 hours with 1 mg (1.3 μmol) of Cy3-N-hydroxy-succinimide (Cy3-NHS, Amersham Pharmacia), dissolved in 1 ml of DMF. The reaction was started by adding 100 μl of a 5% diisopropylethylamine(DIEA)/DMF-solution; course of reaction and end of reaction were monitored by means of thin-layer chromatography (TLC). Purification was effected via gel-filtration and ion exchange chromatography, and the purity of the fractions was checked by TLC. To produce glass platelets with an epoxide coating, cover glass (Esco, microscope cover glass, 24×50 mm; Erie Scientific, Portsmouth, N.H.) were etched with trifluoro-acetic acid and silanated with glycidoxy-propyltrimethoxy-silane (GPS) according to the publication (Piehler et al., 2000). The quality of the coating was confirmed by contact angle measurements (Dataphysics OCA 20). Coupling Cy3-PEG amine to the silanated glass platelets was effected at a concentration of 20 nM (measurement with UV-Vis spectrophotometer Shimadzu UV1601) in 50 mM borate buffer, pH=8.8, for 10 minutes. Unbound Cy3-PEG-amine in excess was removed by washing several times in water. To visualize the immobilized fluorophores, the fluorescence reading device “Nanoreader” was used. For excitation, a diode-pumped solids laser with a wave length of 532 nm was used, as objective an axiovert PNF 40y/1.3 oil was used. The duration of exposer was 100 ms, and the signal was filtered with a Cy3 filter set (Chroma, HQ610_{—}75m). For image presentation, the program V++ (Digital Optics) was used. FIG. 11 shows an area of 30 μm times 50 μm with single ones and clusters of fluorophores having an average single signal intensity of 15 counts. The signal to noise-ratio was 50 on an average.

### Example 2

To produce a hexagonal dense packing of beads on a surface, beads having a coating of polyethylene glycol (PEG) were used. For coating with PEG, the beads (Latex-Beads, Polysciences, diameter 2 μm, carboxyl surface) were suspended in 20 μl 1M 2-(N-morpholino)-ethanesulfonic acid (MES) buffer at a final concentration of 1 percent by mass, mixed with 1 ml of a solution of 0.1 M MES-buffer, pH=4.5 with 26 mM 1-ethyl-3-(3-dimethylaminopropyl)-carbodiimide and 10 mM methoxy-polyethyleneglycol-amine (Mw 5000, Shearwater Polymers, Huntsville, Ala., USA) and incubated for 2 hours in a shaker at 150 rpm. After the PEG coating, the beads were washed several times and applied in a 1% suspension on a pegylated glass platelet surface. To produce a pegylated glass surface, glass platelets modified by glycidoxypropyl-trimethoxysilane (production cf. Example 1) were incubated with 100 mg methoxy-polyethylene glycol-amine (Mw 5000) (Shearwater Polymers) in 25 ml of 50 mM borate-buffer, pH=8.8, at room temperature for 24 h. FIG. 12 shows a 110 μm-times-60 μl-sized section of a transmitted light-image of pegylated latex beads tightly packed in hexagonal arrangement on pegylated glass platelets, recorded by the Nanoreader.

### Example 3

To demonstrate the use of marker beads, a mixture of non-fluorescent beads and covalently coupling, fluorescent marker beads were applied to a glass substrate. The marker beads bound covalently and remained on the surfacer after washing, while non-coupled beads are detached from the surface. To produce coupling marker beads, fluorescence-labeled silicate beads (sicastar®—redF from Micromod, with carboxyl surface, diameter 2 μm) were modified with PEG-diamine (MW 3400, Shearwater Polymers), via EDC activation. For the modification, the beads were resuspended in 120 μl of 1M MES-buffer, pH=4.5, with a final concentration of 1 percent by mass. This suspension was transferred in 1 ml of 0.1 M MES-buffer, pH 4.5, with 26 mM 1-ethyl-3-(3-dimethylaminopropyl)-carbodiimide (EDC; Sigma) and 10 mM Polyethylene glycol diamine (MW 3400, Shearwater Polymers) and incubated for 2 h in a shaker at 750 rpm. Multiple washing was effected with water. To produce non-coupling beads, non-labeled silicate beads (sicastar® from Micromod, with carboxylate surface, diameter of 2 μm) were incubated in 1 ml of 0.1 M MES-buffer, pH=4.5, with 26 mM EDC and 10 mM methoxy-polyethylene glycol-amine (Mw 5000, Shearwater Polymers) for 2 hours in a shaker (Thermomixer comfort, Eppendorf) at 750 rpm. Washing several times was effected with water. For the occupying experiments with beads, pegylated glass platelets with an amine-reactive surface were used. To produce a pegylated glass surface, glycidoxypropyl-trimethoxysilane-modified glass platelets (production cf. Example 1) were incubated with 100 mg of methoxy-polyethyleneglycol-amine (Mw 5000, Shearwater Polymers) in 25 ml of borate-buffer, pH=8.8, at room temperature for 2.4 hours. After washing several times, the terminal amino-function was modified for 2 hours with succinanhydride (Sigma) in a saturated solution kept at pH=6.2-6.5 by means of 6N NaOH. The carboxylate function formed was activated in 25 ml of DMF with 13 mM N,N,N′,N′-tetramethyl-O—(N-succinimidyl)-uronium-tetrafluoroborate (TSTU) and 6.9 mM NHS under addition of 20 μl triethylamine. Washing was effected with a DMF/isopropanol gradient, finally it was dried in a nitrogen flow. To occupy the coated glass platelets with beads, a mixture of 0.01% marker beads with PEG-amine terminus and 1% beads with PEG-terminus were taken up in borate-buffer, pH=8.8, the mixture was applied to the platelets and incubated for 60 minutes. FIG. 13A shows a transmitted-light image of the adsorbed beads. During incubation, the marker beads coupled to the NHS-activated glass surface by their amine terminus, so that the marker beads remained on the glass platelets after a washing step, while non-coupled beads became detached. FIG. 13b shows a Cy3-fluorescence image of the adhering marker beads after detachment of the non-coupling beads. The imaged plate let region is equal to that in FIG. 13A.

### Example 4

Fluorescence-labeled molecules were controlledly transferred from beads to a planar surface. For this purpose, beads were occupied with amine-PEG-Cy3 and applied to a glass platelet with PEG-NHS coating. At the sites of contact between beads and glass, amine-PEG-Cy3 was transferred to the glass substrate and covalently coupled so that fluorescence-labeled imprints remained after washing off the beads. For this transfer, 20 μl of Silicate Beads (Bangs Laboratories Inc., with carboxylate surface, diameter 5 μm) in PBS buffer, pH=7.3, were resuspended at a final concentration of 10% by mass. This beads suspension was added to 1 ml of PBS-buffer, pH=7.3, with 1.2 μM (1 mg) amine-PEG-Cy3 (synthesis cf. Example 1) and incubated for 2 hours under shaking (Thermomixer Eppendorf comfort) at 750 rpm. After washing several times in PBS buffer, pH=7.3, no fluorescence signal was detected in the supernatant (Fluorescence spectrometer from Hitachi f-4500). Marker beads (Silicat Beads, Bangs Laboratories Inc., carboxylate surface, diameter 5 μm, with a mixed PEG-amine/Cy3-PEG-amine surface, production analogous to Example 3) were added in a 1000-fold excess to the loaded transfer beads. The mixture was applied to the glass platelet with the PEG-NHS coating and incubated for 15 minutes (production of the coated platelets, cf. Example 3). The transfer beads were detached by washing, and the fluorescence-labeled imprints were visualized with the Nanoreader (cf. Example 1). FIG. 14A shows an approximately 100 μm-times-50 μm-sized section with a marker bead of high fluorescence intensity and approximately 100 imprints of low intensity. FIG. 14B shows a partial section of FIG. 14A with imprints of different fluorescence intensities.

### Example 5

To demonstrate the use of color-labeled beads, three types of differently fluorescence-labeled silicate-beads (sicastar® blueF and sicastar® greenF, sicastar® redF, from Micromod, with carboxylate surface, diameter 2 μm each) were utilized. The beads were modified with methoxy-PEG-amine by means of EDC activation (production cf. Example 2). Likewise, the glass substrate was coated with methoxy-PEG-amine (production cf. Example 2). To occupy the glass platelet with beads, a mixture of the three types of beads with equal portions of 0.5% by mass each were suspended in water with a total final concentration of 1.5% by mass and applied to the platelet. For fluorescence uptake of the adsorbed beads, a fluorescence microscope with a mercury-vapor lamp (Zeiss, fluo arc HBO 100) and an objective (Zeiss, Axiovert PNF 40x/1.3 oil) was used. A portion of the image was recorded with three filter sets: DAPI excitation filter: D365/10x, dichroitic beam splitter: 380DCLP, emission filter: D460/50m. FITC exciation filter: HQ480/40x, dichroitic beam splitter: Q505LP-emission filter: HQ535/50m. Cy3 excitation filter: HQ535/50x, dichroitic beam splitter: Q565LP-emission filter: HQ610/75m. Cy5 excitation filter: HQ620/60x, dichroitic beam splitter: Q660LP-emission filter: HQ700/75m. To provide for greater clarity, the individual images were contrasted in color as a function of the emitted wave length, and overlayed with the help of the software V++ (FIG. 15).

The blue beads correspond to the signals of the Sicastar blue, the green beads to those of the Sicastar red, the black beads to those of the Sicastar green.

### Example 6

To demonstrate that molecules can be bound to nanoscopic islands, fluorescence-labeled nanoparticles are coupled to gold islands on a solid substrate via molecular recognition (Streptavidin-biotin). As the nanoparticles, yellow-fluorescent beads (Em/Ext: 505/515 nm) (Molecular Probes) having a diameter of 40 nm and a Neutravidin-coated surface were used. As the substrate with nanoscopic islands, gold islands having a diameter of 50 nm were deposited on a silicon-substrate by means of electro-beam lithography. Subsequently, the surface of the gold islands was modified with N-(6-(biotinamidohexyl)-3′-(2′-pyridyldithio)-propionamide (Biotin-HDPD) (Pierce). Neutravidin-coated nanoparticles were bound to the biotinylated gold is lands. For this purpose, a suspension of 3.6×10⁹ particles/ml in PBs were applied to the modified substrate and incubated for 30 minutes. Beads in excess were removed by washing several times, and specifically bound beads were read out by means of a fluorescence microscope. Reading out was effected with a fluorescence microscope having a mercury-vapor lamp (Zeiss, fluo arc HBO 100) and an objective (Zeiss, Axiovert PNF 100x/1.4 oil). The following filter was used: FITC exciation filter: HQ480/40x, dichroitic beam splitter: Q505LP-emission filter: HQ535/50m.

### REFERENCES

Arbeitman et al. (2002). Science 297, 2270-2275.
Bell et al (2003). Bioconjug Chem 14, 488-493.
Boisset et al. (1994) Ann N Y Acad Sci 737, 229-244.
Braslavsky et al. (2003) Proc Natl Acad Sci USA 100, 3960-3964.
Bruckbauer et al. (2003) J Am Chem Soc 125, 9834-9839.
Chen et al. (2001) Electrophoresis 22, 187-207.
Chen et al. (1998) Condens Matter News 6, 22-30.
Clausen-Schaumann et al. (2000). Curr Opin Chem Biol 4, 524-530.
Edelstein et al. (2000). Biosens Bioelectron 14, 805-813.
Enderlein et al. (2000) Biophys J 78, 2151-2158.
Geddes et al. (2002) J Fluoresc 12, 121-129.
Geddes et al. (2003a) J Phys Chem B 107, 9989-9993.
Geddes et al. (2003b) Langmuir 19, 6236-6241.
Hesse et al. (2002). J Chromatogr B 782, 127-135.
Jeppesen et al. (2001). Science 293, 465-468.
Jung (2000). Combinatorial Chemistry: Synthesis, Analysis, Screening, Vch Verlagsgesellschaft).
Kolb et al. (1997) Science 275, 1097-1099.
Korn et al. (2003) Nucleic Acids Res 31, e89.
Lakowicz, J. R. (2001) Anal Biochem 298, 1-24.
Lakowicz et al. (2002) Anal Biochem 301, 261-277.
Lee et al. (2002) Science 295, 1702-1705.
Levene et al. (2003) Science 299, 682-686.
MacBeath et al. (2000). Science 289, 1760-1763.
Mamin et al. (1990) Phys Rev Lett 65, 2418-2421.
Mehta et al. (1999). Science 283, 1689-1695.
Nicolaou et al. (2002). Handbook of Combinatorial Chemistry: Drugs, Catalysts, Materials, John Wiley & Sons).
Nie et al. (1997). Annu Rev Biophys Biomol Struct 26, 567-596.
Piehler et al. (2000). Biosens Bioelectro 15, 473-481.
Pollack et al. (1999). Nat Genet 23, 41-46.
Renaultt et al. (2003) J Phys Chem B 107, 703-711.
Schindler (2000) WO00/25113
Schmidt et al. (1996). Proc Natl Acad Sci USA 93, 2926-2929.
Schutz et al. (2000). Embo J 19, 892-901.
Segers-Nolten et al. (2002). Nucleic Acids Res 30, 4720-4727.
Sonnleitner et al. (1999). Biophys J 77, 2638-2642.
Whitesides et al. (2001) Annu Rev Biomed Eng 3, 335-373.
Xie et al. (1999). J Biol Chem 274, 15967-15970.
Zhang et al. (2000) Langmuir 16, 3813-3817.
Zhang et al. (2001) Chem Commun, 1906-1907.
Zhu et al. (2001). Science 293, 2101-2105.

1.-29. (canceled)

30. A method of producing an array for binding single molecules comprising:
applying nanoscopic islands to the surface of a solid substrate by a surface structuring method;
obtaining adapters, wherein the adapters have a two-dimensional size of at least the size of the islands;
obtaining single molecules; and
coupling adapters to single molecules and the nanoscopic islands with any order of coupling such that the islands are bound to the adapters and the adapters are bound to the single molecules;
wherein an array is produced.

31. The method of claim 30, further defined as comprising:
applying nanoscopic islands to the surface of a solid substrate by a surface structuring method;
applying adapters to the nanoscopic islands, wherein the adapters have a two-dimensional size, projected along their normal line to the solid surface, of at least the size of the islands;
coupling single molecules to the adapters that are bound to the nanoscopic islands; and
saturating any unoccupied islands possibly present with variants of adapters which do not carry any molecules.

32. The method of claim 31, wherein:
the nanoscopic islands are gold dots applied to the surface of the solid substrate of glass by scanning tunneling microscopy;
the adapters are dendron adapters comprising non-activated disulfide groups at their peripheries which will bind to the nanoscopic island and N-hydroxysuccinimide functionalities which can couple to the 5′-amine functionality of modified DNA-oligonucleotide single molecules; and
coupling the single molecules to the adapters comprises reacting the amine functionalities of the DNA-oligonucleotides to the N-hydroxy-succinimide functionalities of the dendrons followed by washing any adapters and single molecules which have not bound to the nanoscopic islands.

33. The method of claim 30, further defined as comprising:
applying nanoscopic islands to the surface of a solid substrate by a surface structuring method;
coupling molecules to adapters in solution, wherein the two-dimensional size of the adapters, projected along the normal line to the solid surface, has at least the size of the islands;
separating the non-coupled adapters or non-coupled molecules by purification steps; and
applying the adapters coupled with single molecules to said solid substrate structured with the nanoscopic islands.

34. The method of claim 33, wherein:
the nanoscopic islands are gold dots applied to the surface of the solid substrate of glass by scanning tunneling microscopy;
coupling the single molecules to the adapters in solution comprises reaction of amine functionalities of DNA-oligonucleotides to single N-hydroxy-succinimide functionalities of a dendron core to produce dendron-DNA adapter-single molecule-conjugates;
the dendron-DNA adapter-single molecule-conjugates are purified by removing any non-coupled single molecules or non-coupled dendron-DNA adapters;
the adapter dendron-DNA adapter-single molecule-conjugates are applied to the gold dots by binding non-activated disulfide groups at the dendron peripheries to the islands; and
any dendron-DNA adapter-single molecule-conjugates which have not been bound to the nanoscopic islands are washed from the array.

35. The method of claim 30, wherein purifying comprises gel permeation chromatography.

36. The method of claim 30, wherein the surface structuring method is further defined as scanning tunneling microscopy (STM), dip pen nanolithography (DPN), electron beam lithography (EBL), ion beam lithography (IL), or micro contact printing (μCP).

37. The method of claim 30, wherein the solid surface is a glass, synthetic material, membrane, metal, or metal oxide surface.

38. The method of claim 30, wherein the single molecules form a density from 10⁴ to 10¹⁰ functionalities per cm², and wherein at least 95% of the single molecules have no other type of single molecule located within a chosen radial distance d of them, wherein d is from 0.1 to 100 μm.

39. The method of claim 38, wherein the distance d is from 0.5 to 10 μm.

40. The method of claim 38, wherein at least 99% of the single molecules have no other type of single molecule located within the chosen radial distance d of them.

41. The method of claim 38, wherein the density of the single molecules is from 10⁵ to 10⁹ per cm².

42. The method of claim 41, wherein the density of the single molecules is from 10⁶ to 10⁸ per cm².

43. The method of claim 38, wherein the single molecules are nucleic acids, oligopeptides, polypeptides, or organic molecules.

44. The method of claim 43, wherein the single molecules are RNA molecules, DNA molecules, antibodies, or members of a combinatorial library.

45. The method of claim 30, wherein the nanoscopic islands consist of a metal, an organic, or an inorganic material.

46. The method of claim 30, wherein the nanoscopic islands have a diameter of from 1 to 100 nm.

47. The method of claim 46, wherein the nanoscopic islands have a diameter of from 3 to 70 nm.

48. The method of claim 47, wherein the nanoscopic islands have a diameter of from 5 to 50 nm.

49. The method of claim 48, wherein the nanoscopic islands have a diameter of from 10 to 30 nm.

50. The method of claim 38, wherein the distance between an individual nanoscopic island is from 0.1 to 100 μm, and the distance between the single molecule bound to the nanoscopic island and the nanoscopic island is independently from 0.1 to 100 nm.

51. The method of claim 50, wherein the distance between the single molecule and the nanoscopic island is from 0.5 to 10 μm.

52. The method of claim 50, wherein the distance between the single molecule and the nanoscopic island is from 1 to 50 nm.

53. The method of claim 52, wherein the distance between the single molecule and the nanoscopic island is from 5 to 30 mm.

54. The method of claim 30, wherein the adapters comprise on one side a binding site to a nanoscopic island on the surface and on a second side a binding site to a single molecule.

55. The method of claim 54, wherein the second side comprises 2, 3 or 4 mutually different binding sites for different single molecules.

56. The method of claim 30, wherein the adapters are inorganic or organic polymers or biopolymers.

57. The method of claim 56, wherein the inorganic or organic polymers are dendrons.

58. The method of claim 56, wherein the biopolymers are proteins or DNA dendrimers.

59. The method of claim 30, wherein the adapters are bound to the nanoscopic islands via a covalent coupling, electrostatic interaction, ligand-complex, biomolecular recognition, chemisorption, or combination thereof.

60. The method of claim 59, wherein the adapters are bound to the nanoscopic islands via a covalent coupling via NH₂, SH, OH, COOH, Cl, Br, I, isothiocyanate, isocyanate, NHS-ester, sulfonyl-chloride, aldehyde, epoxide, carbonate, imidoester, anhydride, maleimide, acryloyl, aziridine, pyridyl-disulfide, diazoalkane, carbonyl-diimidazole, carbodiimide, disuccinimidyl-carbonate, hydrazine, diazonium, aryl-azide, benzophenone, diazirin-groups, or a combination thereof.

61. The method of claim 59, wherein the adapters are bound to the nanoscopic islands via biomolecular recognition further defined as biotin-Streptavidin, antibody-antigen, DNA-DNA interaction, or sugar-lectin recognition or a combination thereof.

62. The method of claim 30, wherein a single molecule is coupled to an adapter such that only one single molecule is bound per structural element on the surface of the solid substrate.

63. The method of claim 30, wherein the coupling of the single molecules to the adapters is via a covalent coupling, electrostatic interaction, ligand-complex, biomolecular recognition, chemisorption, or combination thereof.

64. The method of claim 63, wherein the coupling of the single molecules to the adapters is via a covalent coupling via NH₂, SH, OH, COOH, Cl, Br, I, isothiocyanate, isocyanate, NHS-ester, sulfonyl-chloride, aldehyde, epoxide, carbonate, imidoester, anhydride, maleimide, acryloyl, aziridine, pyridyl-disulfide, diazoalkane, carbonyl-diimidazole, carbodiimide, disuccinimidyl-carbonate, hydrazine, diazonium, aryl-azide, benzophenone, diazirin-groups, or a combination thereof.

65. The method of claim 63, wherein the coupling of the single molecules to the adapters is via biomolecular recognition further defined as biotin-Streptavidin, antibody-antigen, DNA-DNA interaction, or sugar-lectin recognition or a combination thereof.

66. The method of claim 30, further comprising employing the array in a fluorescence microscopic examination.

67. A method comprising obtaining an array produced by the method of claim 30 and employing the array in a fluorescence microscopic examination.

68. The method of claim 67, wherein the fluorescence microscopic examination is a single dye tracing scan or time-delayed integration.

69. The method of claim 67, further comprising binding a biomolecule to the array.

70. The method of claim 69, wherein the biomolecule is an antigen, ligand, protein, DNA, mRNA, toxin, virus, bacteria, cell, or combinations thereof.

71. The method of claim 69, further defined as a method for investigating the cDNA of cells, wherein fluorescence-labeled cDNAs bind to different oligonucleotides on the array and the binding can be read out for each bound cDNA-type.

72. The method of claim 69, further defined as a method for investigating the proteins of cells, wherein fluorescence labeled proteins bind to different antibodies on the array and the binding can be read out for each protein type bound.

73. A method comprising obtaining an array produced by the method of claim 30 and using it in ultra-sensitive fluorescent microscopy, wherein due to the spatial vicinity of the nanoscopic islands, fluorescence signals of individual island-coupled molecules is intensified as compared to molecules which may be non-specifically adsorbed to the regions between said islands.

74. An array comprising a solid substrate, nanoscopic islands on the substrate, adapters bound to the nanoscopic islands, and single molecules bound to the adapters.

75. The array of claim 74, wherein the single molecules form a density from 10⁴ to 10¹⁰ functionalities per cm², and wherein at least 95% of the single molecules have no other type of single molecule located within a chosen radial distance d of them, wherein d is from 0.1 to 100 μm.

76. The array of claim 74, wherein the density of the single molecules is from 10⁵ to 10⁹ per cm².

77. The array of claim 74, wherein the single molecules are nucleic acids, oligopeptides, polypeptides, or organic molecules.

78. The array of claim 74, wherein the nanoscopic islands are comprised of a metal, an organic, or an inorganic material.

79. The array of claim 74, wherein the nanoscopic islands have a diameter of from 1 to 100 nm.

80. The array of claim 74, wherein the distance between an individual nanoscopic island is from 0.1 to 100 μm, and the distance between a single molecule bound to the nanoscopic island and the nanoscopic island is independently from 0.1 to 100 nm.

81. The array of claim 74, wherein the adapters comprise on one side a binding site to a nanoscopic island on the surface and on a second side a binding site to a single molecule.

82. The array of claim 81, wherein the second side comprises 2, 3 or 4 mutually different binding sites for different single molecules.

83. The array of claim 74, wherein the adapters are inorganic or organic polymers or biopolymers.

84. The array of claim 74, wherein the inorganic or organic polymers are dendrons.

85. The array of claim 74, wherein the biopolymers are proteins or DNA dendrimers.

86. The array of claim 74, wherein the adapters are bound to the nanoscopic islands via a covalent coupling, electrostatic interaction, ligand-complex, biomolecular recognition, chemisorption, or combination thereof.

87. The array of claim 74, wherein a single molecule is coupled to an adapter such that only one single molecule is bound per structural element on the surface of the solid substrate.

88. The array of claim 74, wherein the coupling of the single molecules to the adapters is via a covalent coupling, electrostatic interaction, ligand-complex, biomolecular recognition, chemisorption, or combination thereof.
